(19) United States
(12) Patent Application Publication
(10) Pub. No.: US 2025/0088070 A1
(43) Pub. Date: Mar. 13, 2025

(54) INTEGRATED POWERTRAIN SYSTEM WITH MOTORTRANSFORMER ACTING AS A MOTOR OR AN ISOLATION TRANSFORMER

(71) Applicant: Luigi GIUBBOLINI, Costa Mesa, CA (US)

(72) Inventor: Dr. Luigi Giubbolini, Costa Mesa, CA (US)

(21) Appl. No.: 18/536,156

(22) PCT Filed: Dec. 7, 2022
(86) PCT No.: PCT/US2022/052170

§ 371 Date: Dec. 11, 2023

Related U.S. Application Data
(60) Provisional application No. 63/286,982, filed on Dec. 7, 2021.

(51) Int. Cl. H02K 7/00; H02K 3/28; H02K 11/00; H02K 11/33; H02K 47/04

(52) U.S. Cl. CPC H02K 7/006; H02K 3/28; H02K 11/0094; H02K 11/33; H02K 47/04; H02K 2213/03

(57) ABSTRACT

MotorTransformer device functioning as a Motor or an Isolation Transformer, and Integrated Powertrain System (IPS) for Electric Vehicle (EV). IPS includes a Matrix Converter to bidirectionally convert grid low frequencies (50/60 Hz) into MotorTransformer high frequency (several kHz), enabling MotorTransformer operation at the same frequency and power, in both functionalities, utilizing the same conducting and magnetic materials. IPS operates in two modes: Driving and Vehicle to Grid (V2G). Driving mode: IPS propels the EV with regenerative braking, with the MotorTransformer field coils connected like a poly-phase Motor with rotating magnetic field. V2G mode: ISP fast charges and discharges the EV Battery directly from/to the grid. The MotorTransformer, as a poly-phase Isolation Transformer, comprises primary and secondary windings formed by field coil sets electrically isolated, and coupled with an alternating magnetic field. Controlling a variable reluctance rotor position enables maximum peak power tracking, in both functionalities, with low harmonic distortion.

### CROSS-REFERENCE TO RELATED APPLICATIONS

This PCT patent application claims the benefit of the U.S. Provisional Patent Application Ser. No. 63/286,982, filed 2021 Dec. 7 by the present inventor. The entire disclosure of the application being considered part of the disclosure of this application, and hereby incorporated by reference.

The present invention relates to a bidirectional plug-in electric vehicle with an onboard device capable of working as a motor with regenerative braking for driving or as an isolated fast charger and discharger for energy transfer with an off-board power grid.

### BACKGROUND

### Prior Art

The following is a tabulation of some prior art that presently appears relevant:

### U.S. Patents

| | Kind | | |
|---|---|---|---|
| U.S. Pat. No. | Code | Issue Date | Patentee |
| 4,757,171 | A | 1988 Jul. 12 | Litton Systems, Inc. |
| 4,801,775 | A | 1989 Jan. 31 | Microwave Products of |
| | | | America, Goodman Co LP |
| 0,273,459 | A1 | 2019 Sep. 05 | ZF Friedrichshafen AG |
| 10,562,404 | B1 | 2020 Feb. 18 | University of Maryland |
| | | | at Baltimore |
| 0,170,890 | A1 | 2021 Jun. 10 | Magna International Inc |
| 10,507,716 | B2 | 2019 Dec. 17 | General Electric Co |

### Foreign Patent Documents

| Foreign | Cntry | Kind | | |
|---|---|---|---|---|
| Doc. | Code | Code | Pub. Date | Applicant or Patentee |
| 053,304 | WO | A | 2012 Apr. 26 | Nissan Motor Co., Ltd |
| 149,944 | WO | A1 | 2020 Jul. 23 | Futurewei Technologies, Inc. |
| 6,924,061 | JP | B2 | 2021 Aug. 25 | General Electric Co |
| 178,892 | WO | A1 | 2022 Sep. 01 | Huawei Digital Power |
| | | | | Technologies Co., Ltd |

### Non Patent Literature Documents

Austin Hughes and Bill Drury; “Electric Motors and Drives. Fundamental, Types, and Applications”; ISBN: 978-0-08-098332-5
Rajib Mikail, “Fundamentals of Electric Motors and Transformers”; Short Course on Energy Efficiency; ISBN: 984-32-1803-6
Danilo Herrera, Javier Villegas-Nunez, Eduardo Ramon Galvan, and Juan Manuel Carrasco; “Synchronous Reluctance Six-phase Motor proved based EV Powertrain as Charger/Discharger with Redundant Topology and ORS control”; November 2019; IET Electric Power Applications 13(11)
SAE J2836; “Instructions for Using Plug-In Electric Vehicle (PEV) Communications, Interoperability and Security Documents”
SAE J2847; “Communication Between Plug-In Vehicles and Off-Board DC Chargers”
EC/ISO 15118-1; “Road Vehicles-Vehicle To Grid Communication Interface—Part 1: General Information And Use-Case Definition”
EC/ISO 15118-2; “Road Vehicles-Vehicle-To-Grid Communication Interface—Part 2: Network And Application Protocol Requirements”
IEC 62196-1; “Plugs, Socket-Outlets, Vehicle Connectors And Vehicle Inlets-Conductive Charging Of Electric Vehicles—Part 1: General Requirements”
IEC 62196-2; “Plugs, socket-outlets, vehicle connectors and vehicle inlets-Conductive charging of electric vehicles—Part 2: Dimensional compatibility requirements for AC pin and contact-tube accessories”
IEC 62196-3; “Plugs, socket-outlets, vehicle connectors and vehicle inlets-Conductive charging of electric vehicles—Part 3: Dimensional compatibility requirements for DC and AC/DC pin and contact-tube vehicle couplers”
SAE J2954; “Wireless Power Transfer for Light-Duty Plug-in/Electric Vehicles and Alignment Methodology”

### Previously

Plugin Electric Vehicle (EV) fast charging and discharging is currently performed by off-board Direct Current (DC) Electric Vehicle Supply Equipment (EVSE), which are bulky and high in cost. In fact, because of their size, weight, and volume, the DC EVSE cannot be integrated onboard the EVs. Current EV's onboard technology does not support fast charging and discharging directly from the grid.

FIG. 1 shows the prior art of an Electric Vehicle 102 (EV) that includes the following subsystems:
An In-vehicle Interface 104 between EV 102 and the driver.
A Low Voltage Electrical 106 on-board system including 12V DC battery supplying the EV 102 subsystems.
A Motors 108 device comprising at least an electric traction motor for propelling the EV 102.
A Bidirectional Inverters 110 device to control the torque and the speed of the Motors 108.
An Energy Storage Device 112 (ESD) comprising a High Voltage (HV) battery and Management System.
A Connector 114 device for charging the ESD from an off-board energy source or to discharge the ESD to an off-board load.
A HV DC Contactors 116 device to control the DC charging, and/or discharging, of the ESD 120 from/to an external DC source/load connected to the Connector 114.
An AC Isolated Charger 118 device to AC charge, or discharge, the ESD 120 from/to an external AC source/load connected to the Connector 114.

Depending on the EV 102 model/brand, the Bidirectional Inverters 110 and Motors 108 are capable of handling high power and the ESD 112 are capable of storing high energy.

A parked EV 102 can be connected through Connector 114 to an off-board Electric Vehicle Supply Equipment (either AC EVSE 202 or DC EVSE 302) to charge its ESD 112. Power between AC EVSE 202, or DC EVSE 302, and EV 102 can be delivered as AC or as DC through the Connector 114. The charging time is determined by the ESD 112 capacity, its max charging rate, the power of the AC Isolated Charger 118, and the available charging power from AC EVSE 202 or DC EVSE 302.

The communication protocol, physical interconnection, and electrical limits between the off-board EVSE, 202 or 302, and EV 102 are defined by SAE (J2836 and J2847), IEC/ISO (15118-1 and 15118-2), and IEC (62196-1, 62196-2, and 62196-3). In addition to the conductive coupling device Connector 114, the charging and discharging energy can be transferred by other types of coupling devices, including inductive, radiative, and capacitive. SAE J2954 defines the inductive coupling for Light-Duty Plug-in/Electric Vehicles and Alignment Methodology.

FIG. 2 shows an off-board Alternating Current (AC) Electric Vehicle Supply Equipment 202 (AC EVSE) with the AC Cable 204 connected to the Connector 114 of the EV 102. The AC EVSE 202 includes:
The AC Cable 204,
An AC EVSE Controller 206,
An AC EVSE Contactors and Filters 208.

The AC EVSE Contactors and Filters 208 connects the onboard AC Isolated Charger 118 to the AC Power Grid 210 and is controlled by the AC EVSE Controller 206. This subsystem 206 also communicates with the AC Isolated Charger 118 on-board the EV 102 through the AC Cable 204 according to SAE or IEC protocol standards depending on brand and model of the EV 102. Simultaneously, 206 communicates with the remote Server 212 though the Network 214. Remote signals of Demand Response (DR) can be sent to the AC Isolated Charger 118 from the Power Utility managing the grid 210 supplying the AC EVSE 202 through the Server 212, the Network 214, and the AC EVSE 202. Thus, DR signals can control the charging power to curtail load on the AC Power Grid 210 as demanded by the Power Utility.

The on-board AC Isolated Charger 118 charges the ESD 112 with charging power typically limited to 20 kW by the weight and size of its isolation transformer mounted within 118 to guarantee isolation between EV 102 and grid. In fact, regardless if the charger is on or off-board, safety standards and codes require isolation between the EV ESD and the grid. This mandates that an isolation transformer is mounted in the on-board charger or in the off-board EVSE between the grid lines and the EV 102 ESD. Electromagnetism laws state that size and weight of an isolation transformer are directly proportional to its power and inversely proportional to its operative frequency. Thus, current practice mandates fast charging with high power chargers that can be located only off-board because of the weight and size of their isolation transformer operating at the low frequency of the grid (50 or 60 Hz).

FIG. 3 shows an off-board DC Electric Vehicle Supply Equipment 302 (DC EVSE) with the DC Cable 304 connected to the Connector 114 of the EV 102.

The DC EVSE 302 includes:
The DC Cable 304,
A DC EVSE Controller 306,
An Isolated Bidirectional Charger/Discharger 308.

The DC EVSE Controller 306 communicates with the ESD 112 on-board the EV 102 through the DC Cable 304 and Connector 114 according to SAE, IEC, or CHAdeMO protocols depending on brand and model of the EV 102. This subsystem 306, in coordination with the ESD 112, controls the direction and the power of the Isolated Bidirectional Charger/Discharger 308. Simultaneously, 306 communicates with the remote Server 212 though the Network 214.

The DC EVSE 302 is off-board, thus the weight and size of its Isolation Transformer are not constrained and the EVSE power can be high enough to fast or ultra-fast charge (and optionally discharge) the EV 102. DC EVSE of 1,000 pounds (or more) can charge the ESD battery at ultra-high power (250 KW, or above) in a short time. The DC EVSE can be capable only of charging or of charging and discharging the ESD. In the latter case, the EVSE can be also remotely controlled to supply energy to the grid and the EV 102 operates as a Distributed Energy Resource.

Remote signals of Demand Response (DR) and Distributed Energy Resource (DER) can be sent to the ESD 112 from the Power Utility managing the grid 210 supplying the DC EVSE 302 through the Server 212, the Network 214, the DC EVSE 302, and the Connector 114. Thus, DR and DER signals can control the charging and discharging power to curtail load on, or deliver energy to, the AC Power Grid 210.

Power density of power electronic converters has roughly doubled every 10 years since 1970. This trend is due to the continuous advancement of power semiconductor devices, which has allowed an increase in the converter switching frequencies by a factor of 10 every decade. Standard charger technology is approaching the limits of the law of physics: isolated, high efficiency (>96%), high power (>200 kW), high switching frequency (>200 kHz), and water-cooled power converters available on the market have power density and specific power higher than 10 kW/dm3 and 5 kW/kg, respectively. The minimum size and weight of the heat sink (air or liquid cooled) for the electronic components is limited by thermodynamic laws. They are proportional to the power and inversely proportional to their efficiency.

Thus, with the current state of the art, high frequency switching electronics are not a problem. What prevents the integration of a fast charger on-board a vehicle is the weight and size of the isolation transformer. In fact, the isolation required by electric vehicle safety standards does not allow isolation implemented by simple diodes and capacitors circuits.

Combining the motor and the transformer structures in a transmotor device is known in the prior art. The transmotor structure offers space and cost savings and other advantages over the use of separate transformers and motors used in combination in certain applications. In fact, transformers and motors utilize large quantities of ferromagnetic material for the magnetic circuit and conductive material for the windings to accomplish their respective functions. For example, a transmotor device, of particular utility in a microwave oven, drives a fan and, at same time, supplies a stepped down voltage to the oven controller and display.

Transmotors have been used for the application of traction and isolated charging/discharging of electric vehicles by adding magnetic material, e.g. iron, and electric conducting material, e.g. copper, to the motor. However, transmotors operate at grid frequency that is very low (50/60 Hz) compared to the operating frequency of EV motors (several kHz), therefore transmotors are bulkier and heavier than grid isolation transformers.

Currently, electric vehicles employ the on board AC electric charger of low power to limit the weight and size of its isolation transformer. Thus, limiting the onboard battery charging speed. This problem has been addressed by the implementation of transmotors without and with isolation, but these had and still have significant problems. Transmotors without isolation do not meet safety standards. Transmotors with isolation do not significantly increase the overall power density, therefore subject to the same limitations of charging speed for the same weight and volume of the AC electric charger on board the electric vehicle.

An Integrated Charging (IC) system integrates battery charging functionality with a vehicle's onboard electric drive system and power electronics. While charging using IC, the EV may be stationary and the terminals of the stationary motor may be connected to the utility grid to enable fast charging. The fundamental current flowing through the phases of a motor/generator would have a frequency of the grid. Rotating magnetic fields produced by the current in the air gap between motor stator and the locked rotor can cause problems, particularly in permanent magnet (PM) machines commonly used in the prior art. Such problems include: a) asymmetry in the phase voltage waveforms depending on the motor type and phase inductances; b) torque oscillation and hence, mechanical vibration; c) copper, core, magnet losses and temperature rise of varied levels depending on the PM motor type due to current, magnetic field and harmonics; and d) irreversible demagnetization of the magnets, if the motor is not optimally designed for both integrated charging and traction applications.

### SUMMARY

In accordance with one embodiment an Electric Vehicle comprises an Integrated Powertrain System and bidirectional coupling devices to the grid.

In accordance with another embodiment an Integrated Powertrain System comprises a MotorTransformer with a Matrix Converter and a Bidirectional Inverter, other power devices, and a controller.

In accordance with another embodiment a MotorTransformer device and method comprises multiple mechanical and electrical ports, multiple field coils, multiple magnetic circuits, and multiple electrical switches.

Other embodiments are envisioned and some are described in the following.

### Advantages

Thus several advantages of one or more aspects of the embodiments are as follows: to provide an EV 102 that transfers kinetic and electrical energy bidirectionally amongst onboard, electrical and/or mechanical devices, ESD 112 and off-board grids, to provide an Integrated Powertrain System that is on-board, that does not add weight and size to the EV 102, that can act as a motor for traction of the EV 102, that can act as a generator when the EV 102 motor is braking and the kinetic energy of the EV 102 flows back into the ESD 112 or to the AC Power Grid 210, that can act as an isolation transformer, that enables the EV 102 to be plugged directly into the AC Power Grid 210, that can charge and discharge the on-board ESD 110 extremely fast from and to the off-board AC Power Grid 210, that can be coupled to the off-board AC Power Grid 210 by electrical coupling conductive, capacitive, inductive, and radiative devices, that makes the off-board DC EVSE 302 unnecessary and thus overcomes the above-mentioned deficiencies in the art, reducing charging time and range anxiety, reducing the infrastructure complexity and cost, thus creating multiple standard interoperability, that can modulate intensity and direction of the energy flow between the ESD 110 and the grid 210, that enables the EV 102 to operate as energy storage for the grid 210 according to DR and DER signals from Power Utilities becoming a distributed energy resource (and not just grid load), that enables a new approach of using energy stored in EV 102, for example in case of emergency events and used for demand response and emergency situations for critical facilities (e.g. hospitals, fire stations, etc.) during blackouts. Other advantages of one or more aspects will be apparent from a consideration of the drawings and ensuing description.

### DRAWINGS—FIGURES

FIG. 1 shows a schematic diagram of a conventional electric vehicle.

FIG. 2 shows a schematic diagram of a conventional electric vehicle connected to an off board AC Electric Vehicle Supply Equipment.

FIG. 3 shows a schematic diagram of a conventional electric vehicle connected to an off board DC Electric Vehicle Supply Equipment.

FIG. 4 shows a schematic diagram of an electric vehicle equipped with the Integrated Powertrain System and a conductive coupler to the off-board power grid.

FIG. 4A shows a schematic diagram of an electric vehicle equipped with the Integrated Powertrain System and a WiFi coupler to the off-board power grid.

FIG. 5 shows a schematic diagram of the Integrated Powertrain System with a low level of integration, in accordance with one embodiment of the invention.

FIG. 5A shows a schematic diagram of the Integrated Powertrain System with a high level of integration, in accordance with another embodiment of the invention.

FIG. 5B shows a schematic diagram of the Integrated Powertrain System with six field coils, three-phases, as an example, operating in “Driving” Mode when the electric vehicle is driving.

FIG. 5C shows a schematic diagram of the Integrated Powertrain System with six field coils, three-phases, as an example, operating in “Conductive Vehicle to Grid” Mode when the electric vehicle is parked.

FIGS. 5Da and 5Db show a schematic diagram of the Integrated Powertrain System with six field coils organized in two three-phases isolated Wye circuits and a multi-port Matrix Converter.

FIG. 5E shows the same schematic diagram of FIG. 5C implemented with a high level of integration.

FIG. 5F shows a similar schematic diagram of FIG. 5E implemented with eight field coils instead of six, and four phases instead of three.

FIG. 6 shows a schematic diagram of the MotorTransformer device configured as a Motor operating in “Driving” Mode with six field coils and three phases, as an example.

FIG. 6A shows a schematic diagram of the MotorTransformer device configured as an Isolation Transformer operating in “Conductive Vehicle to Grid” Mode with six field coils and three phases, as an example.

FIG. 6B shows a variant of FIG. 6 with four phases.

FIG. 6C shows a variant of FIG. 6 with six phases.

FIG. 7 shows a schematic diagram of the MotorTransformer device configured as motor.

FIG. 7A shows the same schematic of FIG. 7 with the circuit configured to disable the MotorTransformer rotation and acting as an isolation transformer with two three-phase electric ports.

FIG. 8 shows the MotorTransformer typical torque, power, and frequency characteristic for motor and transformer configurations for the “Driving” and “Conductive Vehicle to Grid” Modes of the Integrated Powertrain System.

FIG. 9 shows a schematic diagram of the MotorTransformer device with variable reluctance in the motor configuration and with two three-phase electric ports.

FIG. 9A shows the same schematic of FIG. 9 with the circuit configured to disable the MotorTransformer rotation and in isolation transformer configuration.

FIG. Abstract shows a block diagram of the Integrated Powertrain System.

FIGS. 10 and 11: MT with switches for arbitrary coil configuration and switching sequence.

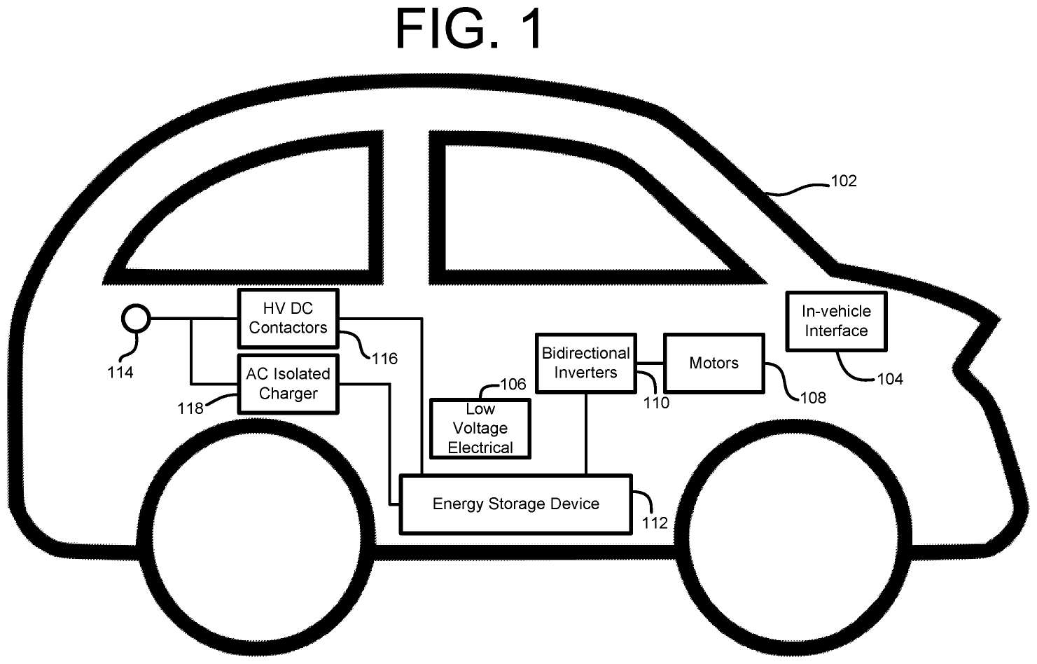

### DRAWINGS—REFERENCE NUMERALS

| | |
|---|---|
| 102 | Electric Vehicle (EV) |
| 104 | In-vehicle Interface |
| 106 | Low Voltage Electrical |
| 108 | Motors |
| 110 | Bidirectional Inverters |
| 112 | Energy Storage Device (ESD) |
| 114 | Connector |
| 116 | HV DC Contactors |
| 118 | AC Isolated Charger |
| 202 | AC Electric Vehicle Supply Equipment (AC EVSE) |
| 204 | AC Cable |
| 206 | AC EVSE Controller |
| 208 | AC EVSE Contactors and Filters |
| 210 | AC Power Grid |
| 212 | Server |
| 214 | Network |
| 302 | DC Electric Vehicle Supply Equipment (DC EVSE) |
| 304 | DC Cable |
| 306 | DC EVSE Controller |
| 308 | Isolated Bidirectional Charger/Discharger |
| 402 | Integrated Powertrain System (IPS) |
| 404 | AC-WiFi EVSE |
| 406 | EV WiFi Coupler |
| 408 | WiFi Coupler |
| 501 | Electric Port (EP) of MotorTransformer |
| 502 | MotorTransformer (MT) |
| 503 | Field Coil (FC) |
| 504 | Configuration Switch-Set (CSS) |
| 505 | Magnetic Circuits (MG) |
| 506 | Bidirectional Inverter (BI) |
| 508 | Matrix Converters (MC) |
| 510 | HV Contactors |
| 512 | Controller |
| 514 | Battery |
| 516 | Flywheel |
| 601 | multi-port Matrix Converter |
| 801 | MT typical torque, power, frequency |
| | characteristic as motor and as transformer |

### Abbreviations

| | |
|---|---|
| AC | Alternate Current |
| AC EVSE | AC Electric Vehicle Supply Equipment |
| AC-WiFi EVSE | AC-WiFi Electric Vehicle Supply Equipment |
| BI | Bidirectional Inverter |
| CSS | Configuration Switch-Set |
| DC | Direct Current |
| DC EVSE | DC Electric Vehicle Supply Equipment |
| DR | Demand Response |
| DER | Demand Energy Response |
| ESD | Energy Storage Device |
| EP | Electric Port |
| EV | Electric Vehicle |
| EVSE | Electric Vehicle Supply Equipment |
| FC | Field Coil |
| HV | High Voltage |
| HVC | High Voltage Contactors |
| IC | Integrated Charging |
| IGBT | Insulated-Gate Bipolar Transistor |
| IPS | Integrated Powertrain System |
| MC | Matrix Converters |
| MG | Magnetic Circuits |
| MT | MotorTransformer |
| PEV | Plugin Electric Vehicle |
| PM | Permanent Magnet |
| PU | Power Utility |
| PWM | Pulse Width Modulation |
| TCP | Torque Corner Point |
| V2G | Vehicle To Grid |

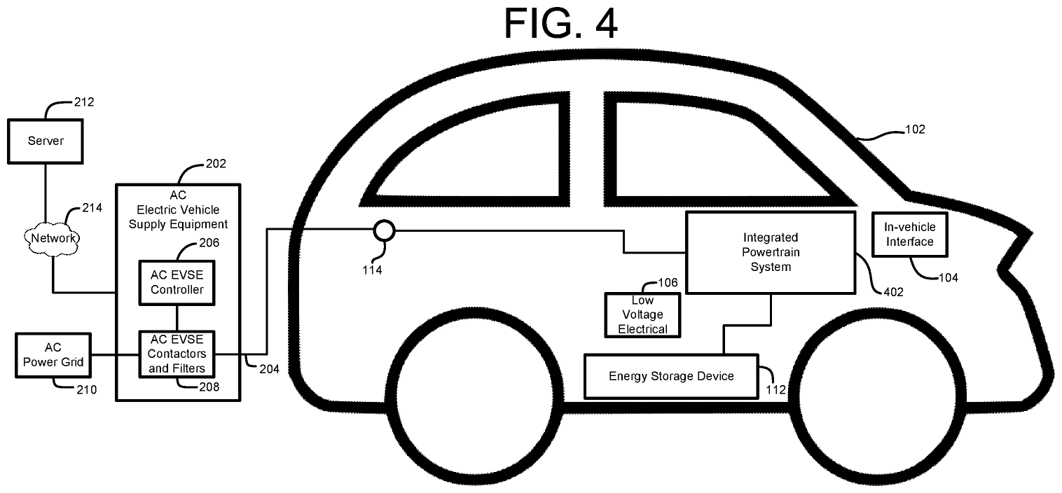

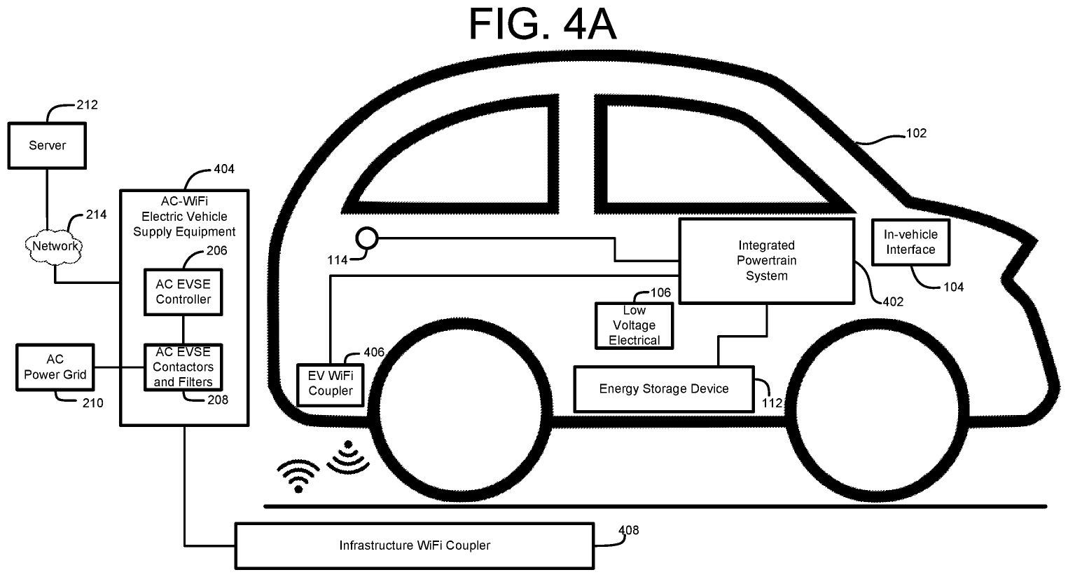

### DETAILED DESCRIPTION—FIGS. 4 AND 4A—FIRST EMBODIMENT

In accordance with one embodiment the Electric Vehicle 102 with the Integrated Powertrain System 402 (IPS) and coupling devices to the AC Power Grid.

FIG. 4 shows the EV 102 with the IPS 402 and the conductive coupler to the grid Connector 114. IPS 402 adds to the traction functionality the capability of extreme fast charging and discharging of the ESD 112, integrating the EV 102 with the grid 210 for DR and DER.

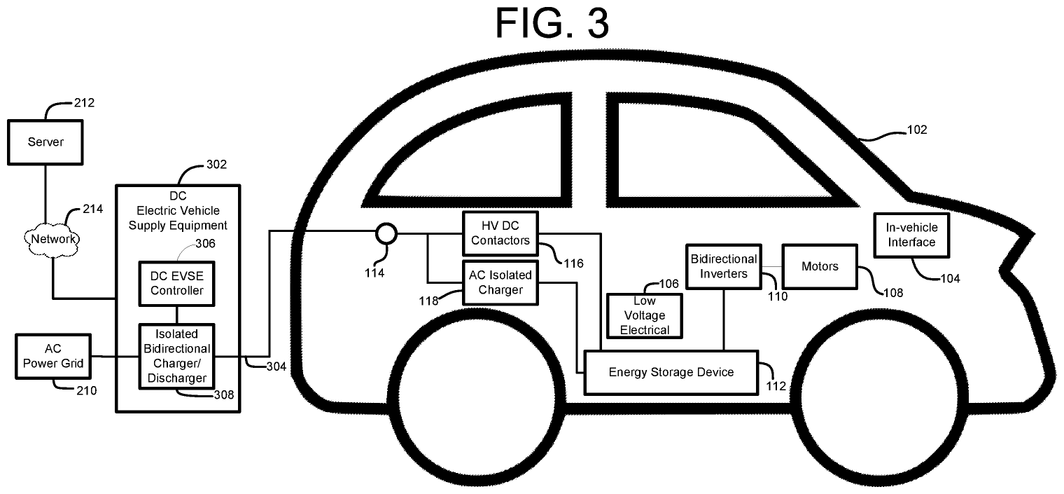

Comparing FIGS. 3 and 4, it is possible to appreciate that the IPS 402 merges the functionalities of the on-board Motors 108 with the off-board DC EVSE 302.

FIG. 4A shows the IPS 402 coupled with an off-board AC-WiFi EVSE 404 capable of wireless bidirectional energy transfer by means of an onboard EV WiFi Coupler 406 and the off-board Infrastructure WiFi Coupler 408 located at the road surface. Coupling between EV 102 and AC-WiFi EVSE 404 can be magnetic, or capacitive, or radiative for wireless charging and discharging, during driving or parking.

### Operation—First Embodiment

While the vehicle is braking, its kinetic energy can be transferred from the IPS 402 to its in-vehicle electric and/or mechanical ESD 112 and/or transferred to the external power grid 210 through EV WiFi Coupler 406. During vehicle acceleration, the electrical energy is transferred from the onboard ESD 112, and, or, from the electric grid 210 through EV WiFi Coupler 406, into the kinetic energy of the vehicle, and vice versa during braking.

The IPS 402 therefore provides both traction and energy regeneration functions, as well as fast charging and discharging to and from the electric power grid when parking or driving. The detailed description and operation of IPS 402 is in the following embodiments.

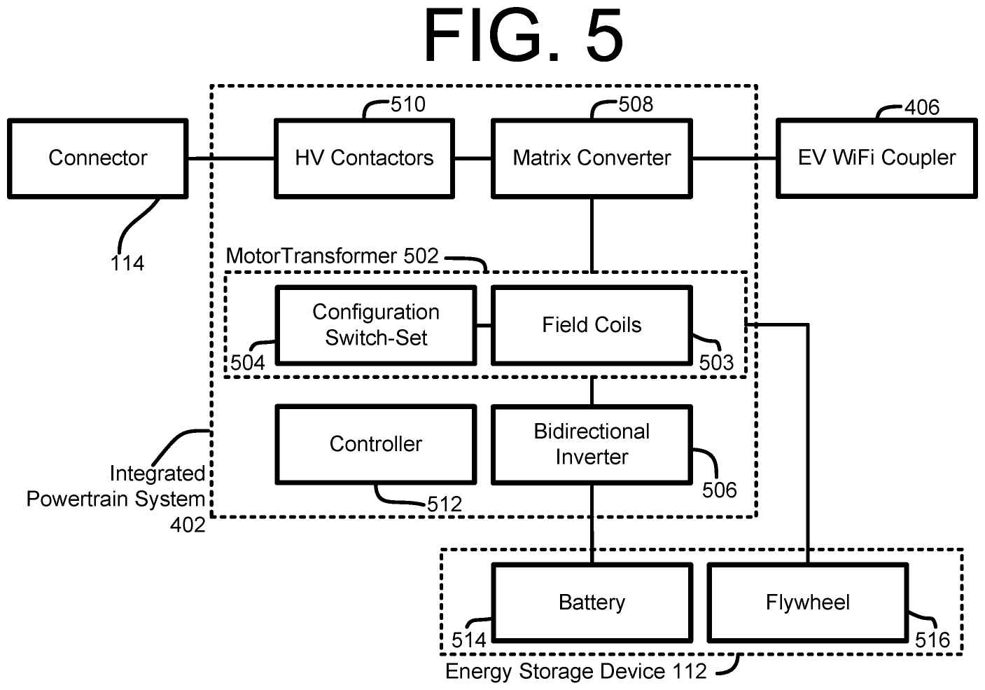

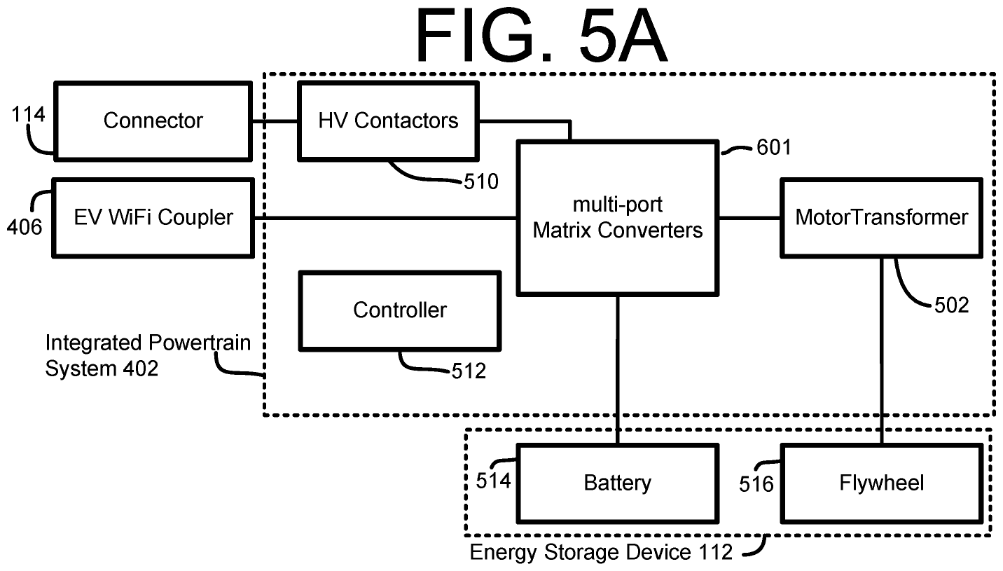

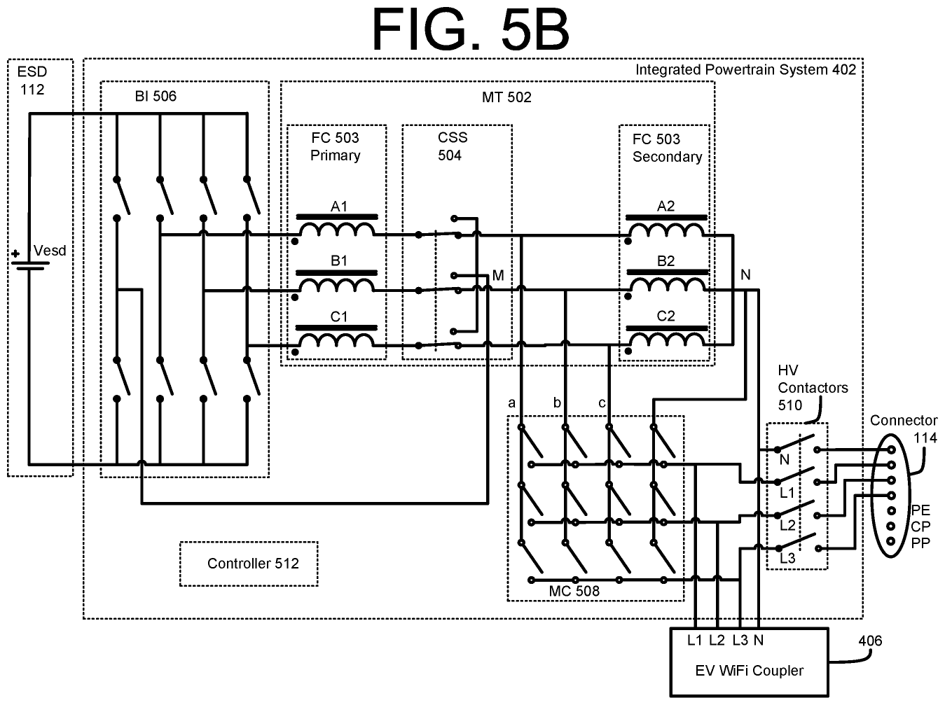

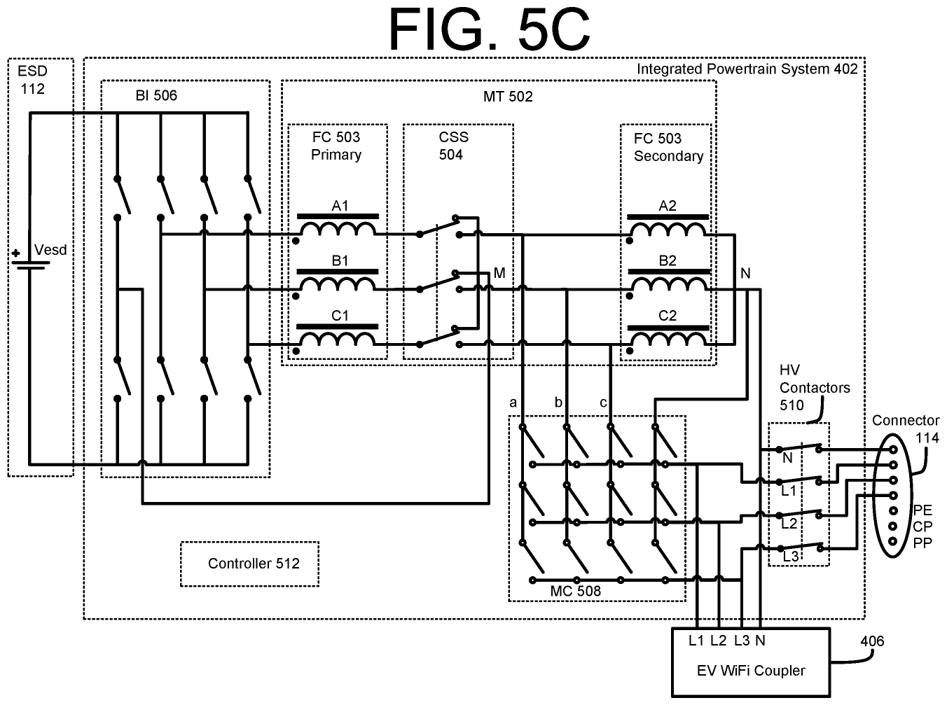

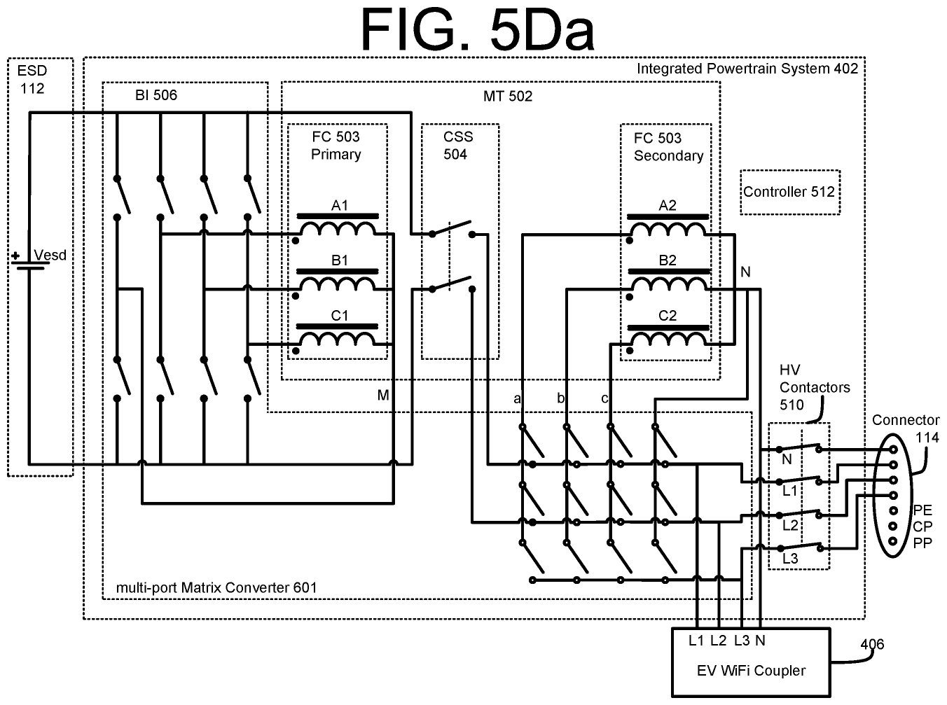

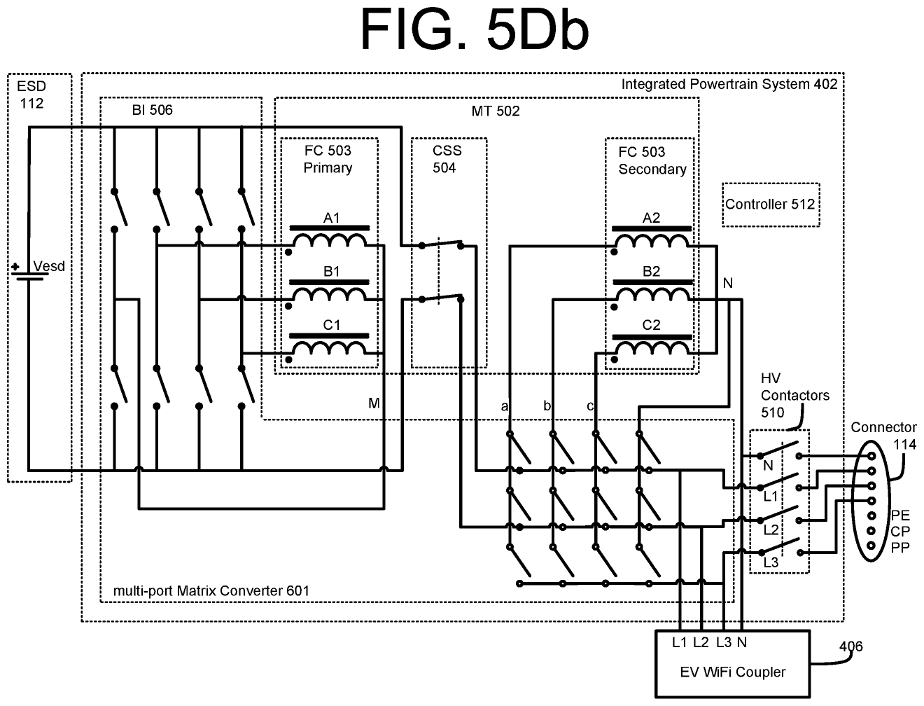

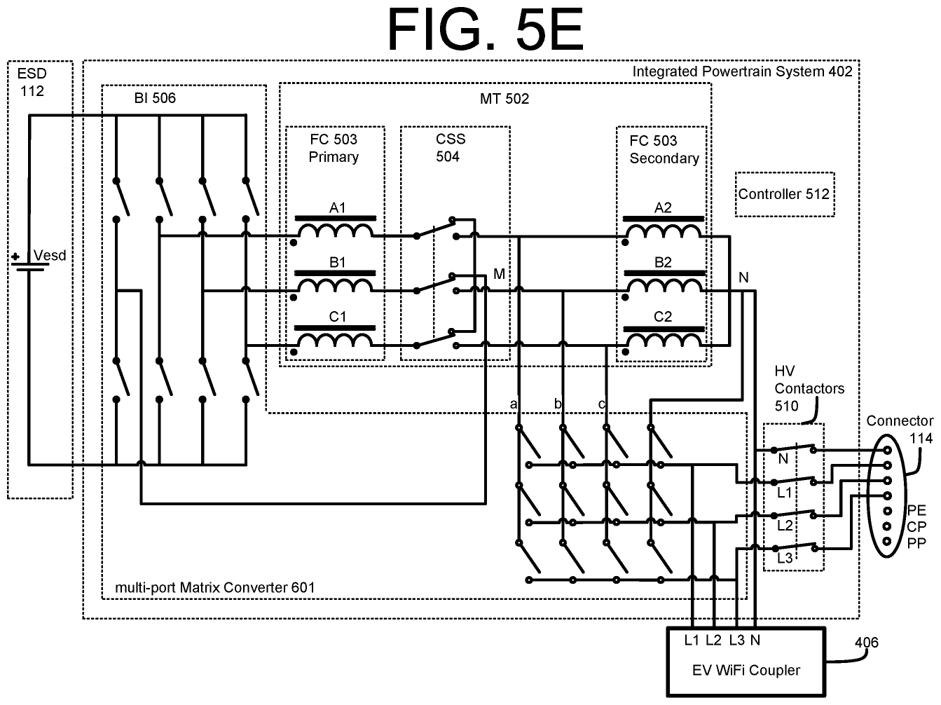

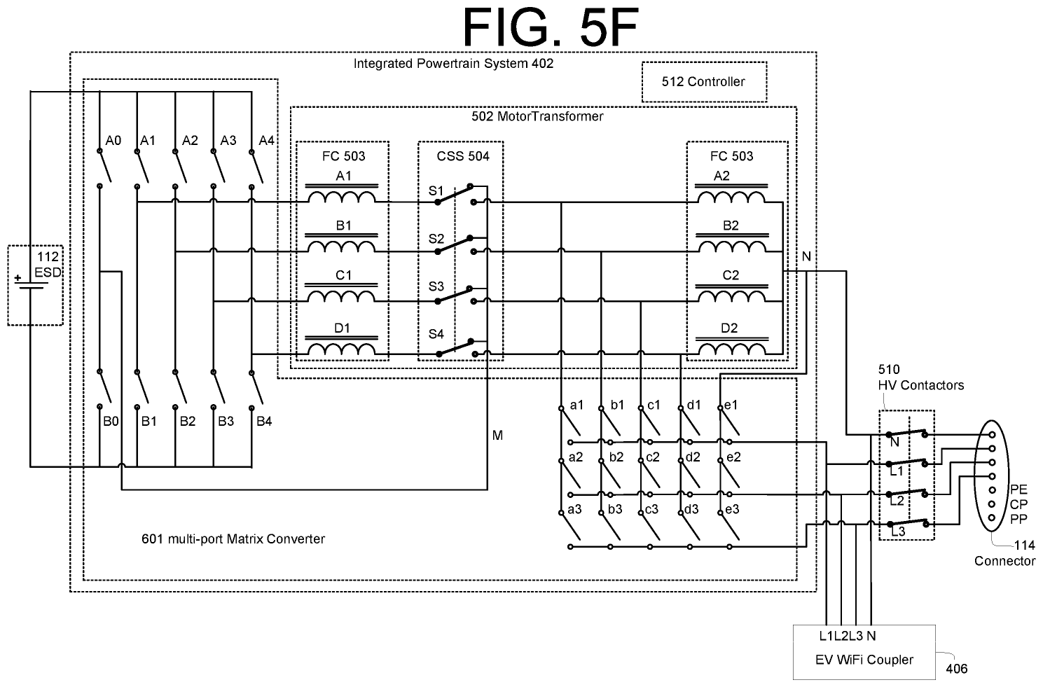

### DETAILED DESCRIPTION—FIGS. 5, AND 5A—SECOND EMBODIMENT

In accordance with another embodiment such IPS 402 comprising a MotorTransformer device MT 502, and other devices. Such IPS 402 bidirectionally transforms and transfers electric and kinetic energy among the grid, the ESD 112, and the electric vehicle. Thus, the IPS 402 provides for the propulsion of the electric vehicle and ultra fast charging and discharging of its ESD 112 from/to the off-board grids while stationary or driving.

FIG. 5 shows this embodiment of the IPS 402 with an example of low level of integration of its internal architecture. It comprises a MotorTransformers 502 (MT) device made up of a Field Coils 503 (FC) and a Configuration Switch-Set 504 (CSS), a Bidirectional Inverter 506 (BI), a Matrix Converters 508 (MC), an HV Contactors 510 (High Voltage Contactors, HVC), and a Controller 512. IPS 402 is electrically connected to the Battery 514, the EV WiFi Coupler 406, the Connector 114, and mechanically to the Flywheel 516 of the ESD 112.

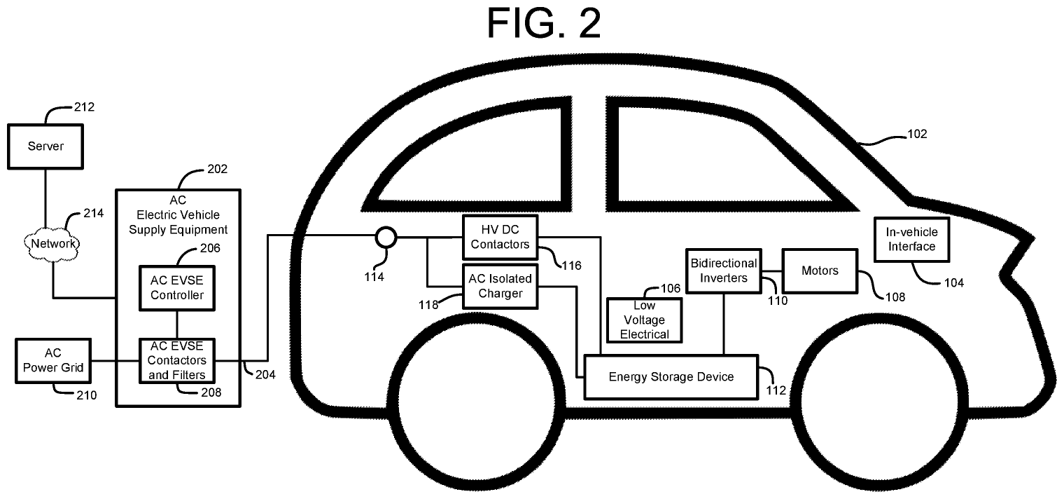

Comparing FIGS. 2 and 5, the traction functionality of Motors 108 is provided by MT 502 operating as a motor. The Bidirectional Inverters 110 is replaced by the BI 506. The HV DC Contactors 116 is replaced by the HVC 510, as there is no need for an external DC EVSE 302 while charging/discharging the ESD 112 directly from/to the AC Power Grid 210.

A variant of the IPS 402 with a high level of integration is illustrated in FIG. 5A. It shows its internal architecture where the BI 506, and the MC 508 are Integrated into a single multi-port Matrix Converter 601.

### Operation—Second Embodiment—FIGS. 5B, and 5C

The Controller 512 controls the MT 502, the BI 506, the MC 508, and HVC 510 switching signals.

CSS 504 can interconnect the Field Coils 503 in at least two hardware configurations. In a “Motor” configuration of the CSS 504, the MT 502 acts as a motor and, simultaneously, as an autotransformer for the “Driving” and “Driving and WiFi Vehicle to Grid” modes. In a “Transformer” configuration of the CSS 504, the MT 502 acts as an isolation transformer for the “Conductive Vehicle to Grid” mode.

In “Isolation Transformer” configuration, one, or more, groups of multi-phase coils, namely primary and secondary coil groups, operate the MT 502 as such isolation transformer with an alternating, non rotating magnetic field, so that the moving parts of the MT 502 are magnetically blocked (e.g. the motor rotor is blocked).

The BI 506 converts the DC power from/to the ESD 112 into AC power to/from the MT 502. The MC 508 converts the AC power from/to the MT 502 into AC power, or DC power, to/from the AC Power Grid 210.

Such IPS is coupled to the grids through the Connector 114 and/or the EV WiFi Coupler 406. The HV Contactors 510 (High Voltage Contactors, HVC) connects the MC 508 to the conductive coupler Connector 114 when EV 102 is parked to transfer energy directly from/to the AC Power Grid 210. The EV WiFi Coupler 406 can transfer energy by means of inductive, capacitive, or irradiation electromagnetic waves while the vehicle is parked or is driving.

A prototype of the IPS 402 with a low level of integration was constructed using a standard EV Motors 108.

The stator was removed from the motor and its housing. The stator windings were removed from the stator and rewound as illustrated in the simplified diagrams of FIGS. 5B and 5C. The stator was then reinstalled in a modified housing.

In this example, used to demonstrate the performance of the embodiment, the MT 502 is made up of six coils FC 503 and a triple-pole double-throw CSS 504. The FC 503 is made up of a brushless rotor mounting a number of permanent magnets and a stator with six poles mounting six coils; the MT 502 is connected to a 3-phase BI 506 and a 3-phase to 3-phase MC 508. Other configurations with multiple poles and coils (on stator and/or rotor) are envisioned and are part of the current embodiment, however, the basic 6-pole configuration of this example is used to illustrate the Integrated Powertrain System 402 concept and operation.

As is well known, the pole configuration of the EV Motors 108 can be designed in a number of different ways depending on the Torque/Speed required for the specific EV 102 as well as other parameters (form factor, cooling, inverter maximum operating frequency current, ESD 112 voltage, etc.). Depending on the number P of MT 502 phases, the BI 506 inverts from DC to P-phase and the MC 508 converts from P-phase to 3-phase, or from P-phase to single phase, (when connected to the 3-phase or single-phase grid), or from P-phase to DC when connected to an off board DC power source or load.

The switch positions of the CSS determine the operating Modes of MT 502. In this embodiment, the two positions of CSS 504 determine the interconnections of the two coil-sets, primary and secondary, of the MT 502. Thus, the primary and secondary magnetic circuits depend on interconnections of the coil-sets.

FIG. 5B shows the CSS position for the “Driving Mode” used to drive the electric vehicle 102. In this mode the MT 502 operates as a motor with regenerative braking, thus electric and kinetic energy are transferred bidirectionally between the ESD 112 and the electric vehicle 102.

FIG. 5C shows the CSS position for the “Conductive Vehicle to Grid (V2G)” mode used to transfer energy bidirectionally between the ESD 112 and the off-board grid when the electric vehicle 102 is parked. In this mode the MT 502 operates as an isolation transformer, the FC 503 Secondary is connected to one side of the MC 508, while the other side of MC 508 is connected to the grid three phase voltage. V2G mode can work in grid-connected with voltage synchronization prior to utility grid connection and in islanded operation modes.

The CSS position of FIG. 5B can be used also for the “Driving and WiFi V2G” mode. In this mode the MT 502 operates simultaneously as a motor with regenerative braking and as an autotransformer for bidirectional energy transfer with the off-board grid coupled with the electric vehicle 102 by the EV WiFi Coupler 106. In this mode the MT 502 transfers energy bidirectionally amongst its three ports, two electrical ports (toward BI 506 and/or MC 508) and one mechanical port, the rotor of MT 502.

In FIG. 5B the MotorTransformer switch CSS 504 is in the “Driving” mode position. In this position, the 3 pairs of windings are connected in series (A1-A2, B1-B2, C1-C2) and then in a Wye connection. FIGS. 5B and 5C show an example of MotorTransformer layout with six coils. In “Driving” mode the MT 502 is capable of propelling the EV 102 and braking regeneratively. Thus, when the EV 102 is in Driving Mode, the MT 502 operates as Motors 108 and the ESD 112 energy is transformed into kinetic energy or, vice versa, depending on the EV 102 driving dynamic.

Thus, in “Driving” mode the MT 502 is operating as a standard Motors 108. The ESD 112 energy is bidirectionally transferred through the 3-phase BI 506 to the MT 502. In this embodiment, the BI 506 converts the ESD 112 DC voltage to 3-phase AC voltage, or vice versa, during the driving, or braking.

The Controller 512 modulates the frequency and phases of voltages and currents applied to MT 502 in order to control the torque and the speed of the motor under the driver's control. The BI 506 can also operate with reversed energy flow, charging the ESD 112 during regenerative braking of the vehicle. When the MT 502 works as Motors 108, the EV Connector 114 is disconnected by the HV Contactor 510, and the MC 508 can operate with the AC-WiFi EVSE 404 while driving.

FIG. 5C shows the same MotorTransformer 402 architecture where the CSS 504 is in the “Conductive Vehicle To Grid Mode” position and the MT 502 functions as an isolation transformer between the ESD 112 and the AC Power Grid 210. In this CSS 504 position the 3 windings A1, B1, and C1 are connected to the BI 506 in a Wye configuration. The second set of windings (A2, B2, C2) is also connected in a Wye configuration and is electrically isolated from, but electromagnetically coupled with, the first set of windings and connected to MC 508. The energy is transferred through the 3-phase BI 506, the MT 502, and MC 508, and the Connector 114 from/to the AC Power Grid 210 to/from the ESD 112. Depending on phases and frequencies modulations of BI 506 and MC 508, the direction and intensity of the energy flow between ESD 112 and AC Power Grid 210 can be controlled in real-time according to user needs and Power Utility DR and DER signals.

The neutral line M of the Primary FC 503 is connected to the midpoint of the fourth leg of BI 506, as shown in FIG. 5C. Similarly, the neutral line N of the Secondary FC 503 is connected to the midpoint of the fourth leg of MC 508.

In the configuration of FIG. 5C, the rotor is not rotating provided that the voltage supplied by BI 506 to the coil A1 is reversed and halved, while the voltage and phase of B1 and C1 remain nominal. In this condition the magnetic field in the rotor is not rotating, but it is alternating along an axis orthogonal to the A1 poles axis. Therefore, in this condition, the MT 502 acts as an isolation transformer, the MT 502 rotor is not rotating with no torque and current ripples. Operating in this way, the BI 506 is an unbalanced 3-phase source supplying the balanced load FC 503 Primary made up of the three coils A1, B1 and C1. This unbalanced source voltage creates an unbalanced current in the Wye neutral line M having amplitude 1.5 times the nominal current amplitude of B1 and C1. This unbalanced current is returned through the M line to the first leg of the BI 506. In a similar fashion, when the energy is transferred from the grid, the voltage supplied by MC 508 to the coil A2 is reversed and halved, while the voltage and phase of B1 and C1 remain nominal. Again, in this condition, the total magnetic field in the rotor is alternating along an axis orthogonal to the A2 poles axis, and it is not rotating, avoiding torque and current ripples. The Neutral line N returns the unbalanced current to MC 508 having amplitude 1.5 times the nominal current of the coils B2 and C2.

In FIG. 5B (EV 102 is driving), when the WiFi infrastructure is not available the MC 508 is powered off. Otherwise, the MC 508 can be used to generate the radio frequency power delivered to the EV WiFi Coupler.

The IPS 402 is bidirectional, thus it can charge, or discharge, the ESD 112 from/to the AC Power Grid 210. The EV Connector 114 can be connected to an AC or DC source/load. When the EV Connector 114 is connected to an AC source/load (grid or microgrid) 210, the MC 508 generates 3-phase AC in phase with the off board AC power lines voltage with amplitude depending on direction and intensity of energy flow as defined by user needs and DR/DER signals. Similarly, when Connector 114 is connected to an off board DC source/load, the MC 508 generates a DC voltage with amplitude similar to that of the off board source, and Controller 512 controls current direction, and thus, energy flow direction and intensity.

### DETAILED DESCRIPTION—FIGS. 5 DA 5 DB, 5E, AND 5F—THIRD EMBODIMENT

In accordance with other embodiments such Integrated Powertrain System 402 is implemented with a high level of integration with a multi-port Matrix Converter 601 including two isolated circuits: a bidirectional inverter section and a matrix converter section, electrically isolated and controlled by the same Controller 512. Wherein the improvement comprises the matrix converter section of 601 functioning as matrix converter or as bidirectional inverter. When the matrix converter section of 601 functions as bidirectional inverter, this section works in parallel with the bidirectional inverter section of 601. The two sections can transfer power to/from MT 502, functioning as motor, from/to the DC battery of ESD 112, and at the same time.

In FIGS. 5Da, 5Db, 5E, and 5F, the Controller 512 device controls the commutation sequences of the multi-port Matrix Converter 601, configures the CSS 504 and the HV Contactors 510.

In the embodiment illustrated in the example of FIGS. 5Da and 5Db, the 601 is connected with a six field coils MotorTransformer divided into two isolated sets, Primary and Secondary, of three field coils each, in the Wye connection.

In FIG. 5Db, 601 is configured in Driving mode, with MT 502 functioning as motor after Controller 512 closes CSS 504 to connects the DC battery voltage of ESD 112 to the matrix converter section of 601, and opens the HV Contactor 510 isolating Connector 114. In this configuration, the matrix converter section of 601 functions as a second bidirectional inverter connected to the Secondary set of field coils FC 503; thus, working in parallel to the bidirectional inverter section of 601 that is connected to the Primary section of FC 503.

In FIG. 5Da, 601 is configured in Conductive V2G mode, with MT 502 configured as isolation transformer, after Controller 512 opens CSS 504 and closes HV Contactors 510 connecting the AC Power Grid 210 to 610 through the Connector 114. In this configuration CSS 504 isolates the DC battery from the matrix converter section of the multi-port Matrix Converter 601 that converts the 3-phase high-frequency AC power of FC 503 Secondary (4 lines total, 3 phases and Neutral) to/from the 3-phase low-frequency AC Power Grid 210. The FC 503 Primary and Secondary Wye windings are electrically isolated, and magnetically coupled, and function as isolation transformer. The power is transferred from the grid 210 to the DC battery 112, and vice versa, through the chain Connector 114, Contactors 510, matrix converter section of 601, MT 502, and bidirectional inverter section of 601.

This embodiment is not limited to MT 502 devices having six field coils in the Wye connection. MT 502 can be implemented as a polyphase induction or as a permanent magnet machine, with multiple poles and coils on stator and/or rotor, with or without variable reluctance, and other electric motor schemes and technologies, in the Wye and/or Delta connections. However, these variants do not change the scope of the embodiment.

In the embodiment illustrated in FIG. 5F is an example of a MotorTransformer schematic with eight field coils divided into two sets, primary and secondary, of four coils each in the Wye connection. The bidirectional inverter section of the IPS 601 converts the ESD 112 DC power into the Primary MT 502 4-phase AC power. The 3×5 matrix converter section of the multi-port bidirectional Matrix Converter 601 converts the MT 502 4-phase AC power (5 lines total, 4 phases with Neutral) to/from the 3-phase AC Power Grid 210.

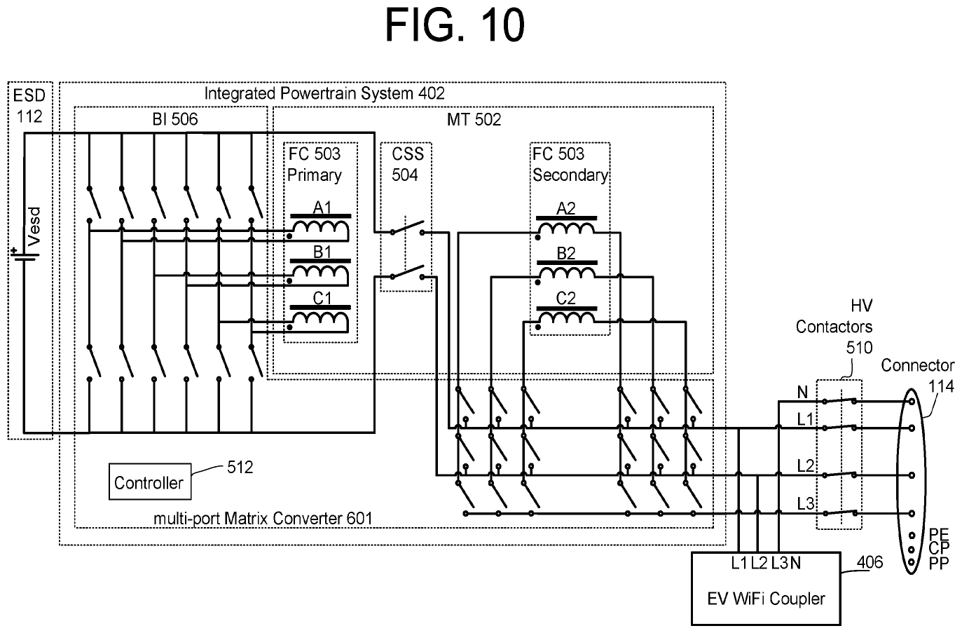

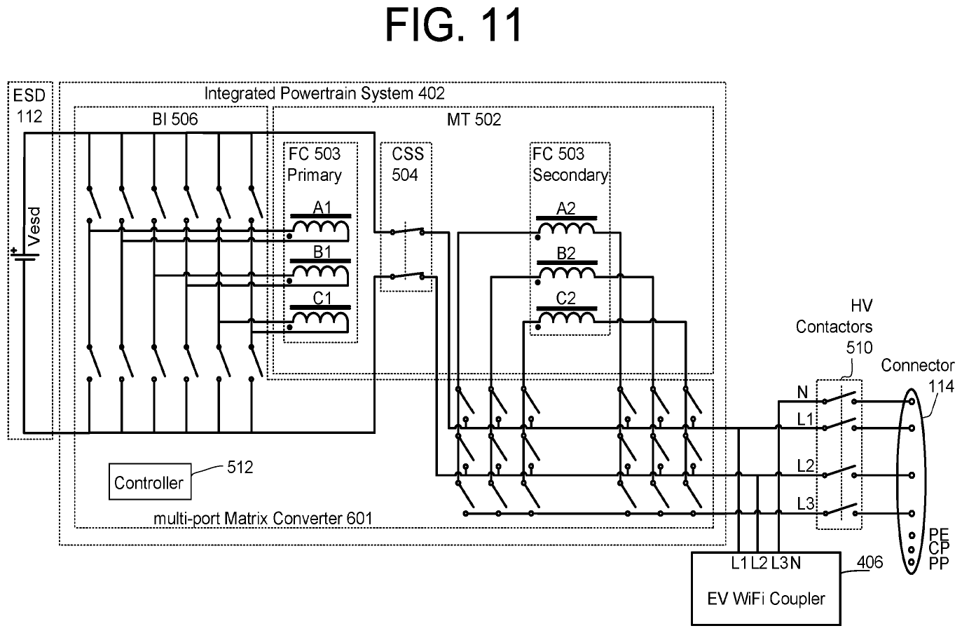

Based on the teachings in this disclosure, one skilled in the art can optimize the number of rotor poles and stator coils, the interconnections, and magnetic circuits in various modes, for the operating characteristics desired. For example, in FIGS. 10 and 11, the two terminals of each field coil are supplied via independent electrical switches.

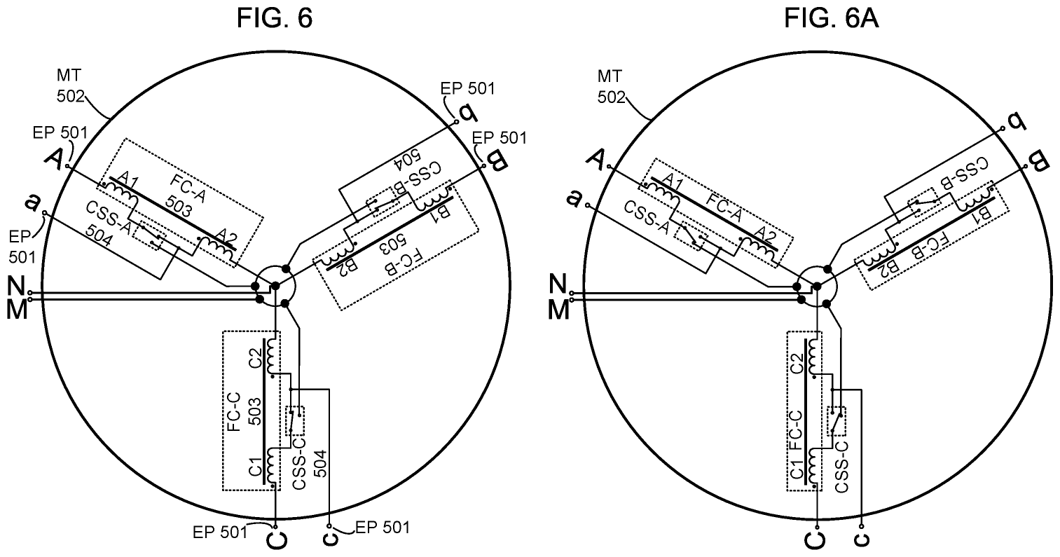

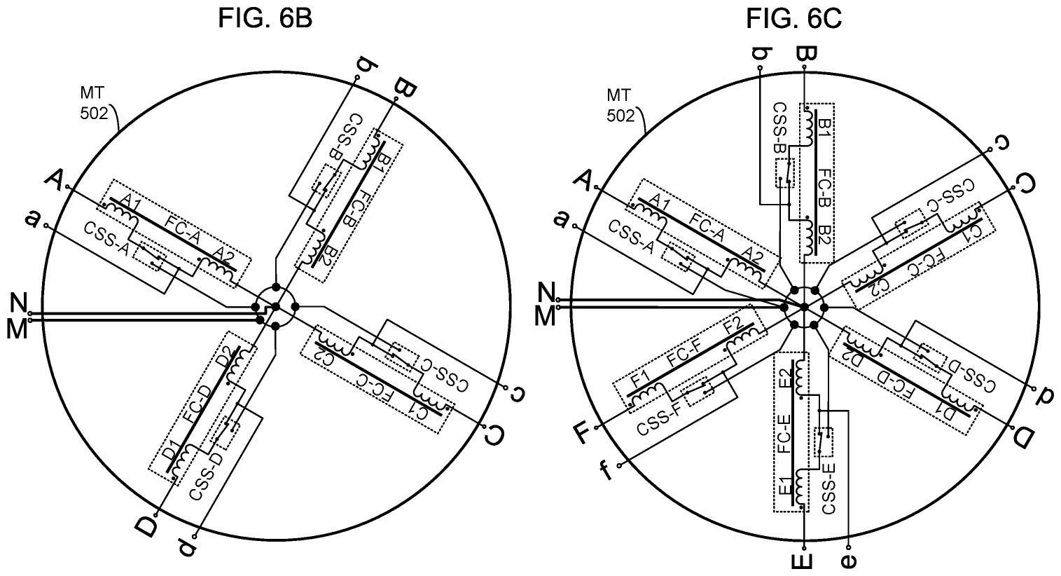

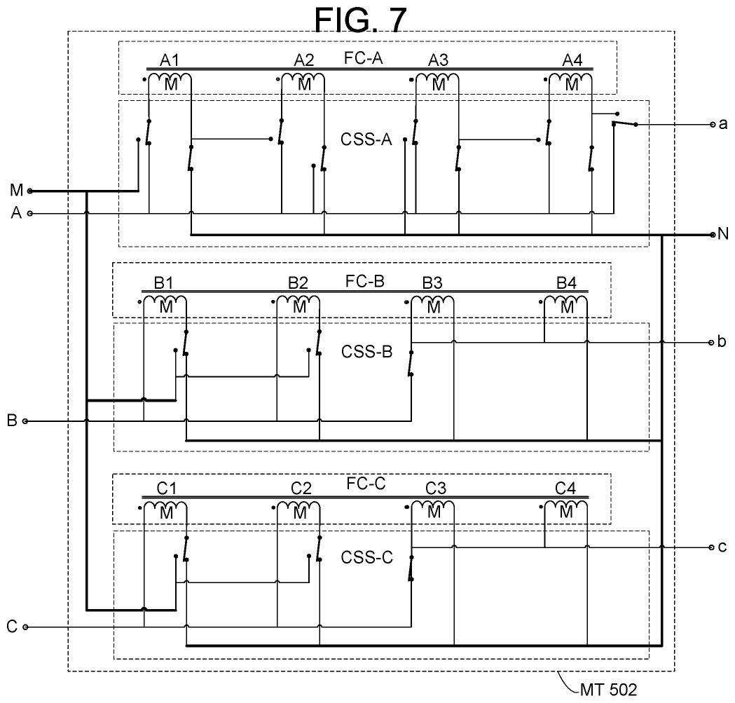

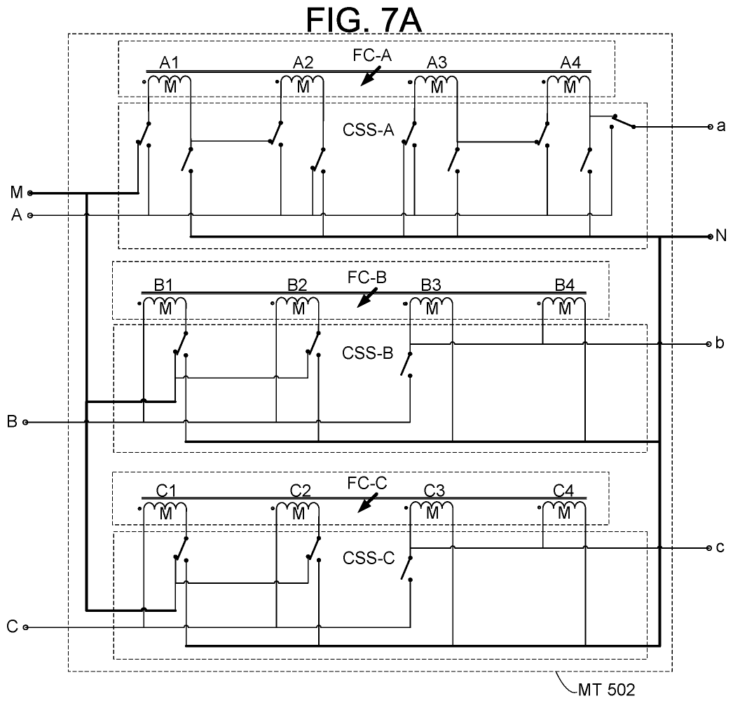

### DETAILED DESCRIPTION—FIG. 6—FOURTH EMBODIMENT

In accordance with another embodiment such MotorTransformer comprising one, or more, mechanical axes and two, or more, electrical ports, multiple field coils and configuration switches. Such MotorTransformer multiple electrical ports and mechanical axes transfer kinetic and electrical energy bidirectionally, amongst onboard electrical and mechanical energy storage devices, electric vehicle kinetics, and off-board grids.

In this embodiment an example of three phase MT 502 is shown in FIG. 6. It provides a mechanical port connected to the rotor, not shown in Figures, and two 3-phase electrical bidirectional ports (A, B, C) and (a, b, c) available to connect to the bidirectional inverter and the matrix converter.

In the “Transformer” configuration of FIG. 6A, the moving parts are static provided that the voltage supplied to the Field Coils 503 A1 is reversed and halved, while the voltage and phase applied to B1 and C1 Field Coils 503 remain nominal. In this condition the total magnetic field in the rotor is not rotating, but it is alternating along the axis orthogonal to the A1 poles axis.

### Operation—Third Embodiment—FIGS. 6, 6A, 6B, and 6C

The circuit shown in FIG. 6 is an example of this embodiment with MT 502 comprising three phases. The circuit can be operated in two or more modes, with components used in both modes to reduce component cost and complexity, save space, and provide high efficiency. Modes may include “Driving”, “Driving and WiFi Vehicle to Grid”, and “Conductive Vehicle to Grid” modes.

CSS 504 configuration of FIG. 6 operates the MT 502 as such motor and autotransformer, thus this “Motor” configuration is suitable for the “Driving” and “Driving and WiFi Vehicle to Grid” modes.

CSS 504 position of FIG. 6A operates the MT 502 as said transformer, thus this “Transformer” configuration is suitable for the “Conductive Vehicle to Grid” mode as providing electrical isolation as required by safety standards.

FIG. 6B shows a variant of this embodiment with four phases MT 502 in “Driving” or “Driving and WiFi Vehicle to Grid” modes.

FIG. 6C shows another possible variant of this embodiment with six phases MT 502 in “Driving” or “Driving and WiFi Vehicle to Grid” modes.

### DETAILED DESCRIPTION—FIGS. 7 AND 7A—FIFTH EMBODIMENT

In accordance with another embodiment of such MotorTransformer comprising one or more mechanical axes, two or more electrical ports, multiple field coils, and configuration switches with at least two circuit configurations. One circuit configuration establishes a physical circuit and current paths through the field coils connected to the electrical ports generating a rotating magnetic field used to drive the mechanical moving parts. Another circuit configuration establishes a different physical circuit and current paths through the field coils generating an alternating, but not rotating, magnetic field coupled with two or more sets of electrically isolated field coils connected to the electrical ports of the MotorTransformer.

Such MotorTransformer multiple electrical and mechanical ports transfer kinetic and electrical energy bidirectionally, amongst onboard electrical and mechanical energy storage devices, electric vehicle kinetics, and off-board grids.

A peculiar characteristic of this embodiment of the MT 502 is that the rotation of its electromagnetic field can be controlled by the CSS 504 switches. In the first mode of CSS 504, the Field Coils 503 are connected in such a way that the electromagnetic field is rotating and the MT 502 works as a motor. This circuit configuration can serve for the “Driving” mode. In another circuit configuration of CSS 504, the Field Coils 503 are connected in such a way as to generate an alternating electromagnetic field, but not rotating, oriented along a stationary axis. In this circuit configuration the rotor of MT 502 does not rotate and the FC 503 forms a circuit such that MT 502 functions as a 3-phase isolation transformer between the two 3-phase ports (A, B, C) and (a, b, c). Therefore, in this circuit configuration of CSS 504, the MT 502 is usable for the “Conductive V2G” mode.

### Operation—Fourth Embodiment—FIGS. 7, and 7A

The circuit shown in FIGS. 7 and 7A is an example of this embodiment with one rotating mechanical axis and two 3-phase electrical ports.

MT 502 comprises three sets of Field Coils 503 (FC-A, FC-B and FC-C) and three sets of Configuration Switch-Set 504 (CSS-A, CSS-B and CSS-C).

The three sets of FC 503 form three pairs of poles respectively oriented at 0, 120 and 240 degrees in the plane orthogonal to the rotating mechanical axis (rotor) of MT 502 as normally assembled in three-phase motors.

Each set of Field Coils 503 consists of four coils, each wound with the same number M of turns, therefore having the same inductance value L. The coils of each set are assembled on the same magnetic circuit in such a way as to be magnetically tightly coupled. Therefore the coupling coefficient (coupling factor) between the four coils of each set is equal to one. Consequently, the mutual induction coefficient between any pair of Field Coils 503 in each set equals the inductance L of a single coil. Thus, when the four coils of a set of Field Coil 503 are connected in parallel, by connecting the terminals having the same polarity, the inductor equivalent of the parallel set has inductance value L, identical to the inductance of a single coil.

Each set of CSS 504 is wired with one phase of the 3-phase system and has two possible positions for the formation of two different electromagnetic circuits defining the operation and functionality of MT 502.

In the first circuit configuration of the CSS 504 shown in FIG. 7, the MT 502 is operating simultaneously as a motor and as an autotransformer. Therefore, in this circuit configuration, the MT 502 can be used for “Driving” or “WiFi Vehicle to Grid” modes. FIG. 7A shows the second position of the CSS 504, in this mode MT 502 acts as an isolation transformer and can be used for the “Conductive V2G” mode.

In the circuit configuration of the CSS 504 shown in FIG. 7, the four coils of each phase are connected in parallel. The three-phase power supplied to the port (A, B, C) generates a rotating magnetic field that drives the rotor of the MotorTransformer MT 502. In this way MT 502 can provide torque and therefore traction to the electric vehicle while driving, or operate in regenerative mode, when the vehicle brakes, thus converting the kinetic energy of the vehicle into electrical energy available at the three-phase port (A, B. C) accumulated in the vehicle Energy Storage Device 112.

In this circuit configuration the four coils of each phase are connected in two isolated circuits which form the primary and secondary of the transformer. Each circuit is made up of two coils in series. Three sets of two isolated circuits form the electromagnetic circuits of the primary and secondary windings of a three-phase transformer.

Considering the circuits of the three phases it is possible to observe that the circuit of phase A is different from those of phases B and C, while the circuits of phases B and C are identical.

Considering the phase A circuit in the “Conductive V2G” mode of FIG. 7A, the two pairs of coils (A1, A2) and (A3, A4) are connected in series by connecting the positive terminal (identified by a dot near the inductor symbols in the drawings of the figures) of the second coil with the negative terminal of the first coil (identified by the absence of the dot). The positive terminals of the two series are connected to the neutral lines M and N. In detail, the positive terminal of the coil A1 is connected to the neutral line M, while the positive terminal of the coil A3 to the neutral line N. The negative terminals of the two series are connected respectively to phases A and a. The equivalent inductor of each series has a total number of turns double the number of turns in a single coil, therefore an inductance value equal to four times the inductance value L of a single coil.

Considering the circuits of phases B and C it can be observed that the four pairs of Field Coil 503 (B1, B2), (B3, B4), (C1, C2) and (C3, C4) are connected in parallel in pairs connecting together terminals with the same polarity. Since the coils of each pair are tightly coupled magnetically, the mutual inductance between coils of each pair is equal to L, the inductance value of a single coil. Thus, the inductor equivalent to each pair of coils has the same inductance value L of a single coil.

The positive terminals of the four pairs are connected to the phase lines B, C, b, c, while the negative terminals to the neutral lines M and N. In particular, the parallels (B1, B2) and (C1, C2) are connected between phases B and C and the neutral line M. Similarly, the pairs (B3, B4) and (C3, C4), associated with the second electrical port of MT 502, are connected between the two phases b and c and the neutral line N.

Phase A is applied to the series of the two inductors (A1, A2); the inductor equivalent of this series has a number of turns equal to twice those of a single coil, thus, an inductance value four times as great. Thus, the magnitude of the magnetic induction vector in the equivalent inductor is equal to half that of a single coil. Furthermore, due to the inverted polarity of this inductor series connection, the orientation of the magnetic induction vector in the magnetic poles of phase A is inverted.

As opposed to the circuit of phase A, in the circuits of phases B and C the inductors are connected in parallel. In particular the inductances B1 and B2 are connected in parallel through phase B and neutral line M. Similarly, for the inductances C1 and C2. Since the inductances in parallel are tightly magnetically coupled, the inductor equivalent to the parallel has an inductance value L equal to that of a single coil, therefore the number of turns of the equivalent inductor equals that of a single coil.

Therefore, the magnetic induction field vector in the poles A of MT 502 in the “Conductive V2G” mode of FIG. 7A has inverted orientation and half the amplitude with respect to the magnetic induction field vector in the same pole A when the circuit is configured for the “Driving” mode as in FIG. 7. The different circuit configurations of CSS 504 modify amplitude and orientation of the magnetic induction field in the A poles, but not in the B and C poles.

The total magnetic induction in MT 502 is determined by the vector sum of the three magnetic induction field vectors generated by the three sets of poles associated with the three phases. The three vectors are parallel to the mechanical axes of the three sets of poles that are physically at 0, 120 and 240 degrees relative mechanical angles defined in a plane orthogonal to the axis of the MT 502 rotor. The amplitude and direction of the three magnetic induction field vectors vary over time according to the value of the three-phase voltages applied, which are out of phase in time with phase angles θ, 120 and 240 degrees.

In the circuit configuration of FIG. 7, MT 502 “Driving” mode, the three magnetic circuits of the three poles are identical, thus the magnetic induction vectors in the three poles have the same magnitude, but different orientation as described above. Their vector sum, the total magnetic induction field vector, is a constant amplitude vector rotating in the plane orthogonal to the rotor with magnitude equal to 1.5 times the magnitude value of the three component vectors. The rotation speed of the total magnetic induction field vector is proportional to the frequency of the three-phase voltages applied. This rotating magnetic field produces the rotation torque on the MT 502 rotator.

In the “Conductive V2G” mode of FIG. 7A, the magnetic induction field vectors in poles B and C are the same as in the “Driving” mode of FIG. 7, however the vector of magnetic induction field in A poles has inverted orientation and half the magnitude compared with those in B and C poles. Thus, the vector sum of the three vectors is not rotating, but alternating, and oriented in the direction of the A poles. Therefore, the MT 502 rotor does not rotate when the circuit configuration of MT 502 is in the “Conductive V2G” mode. Although it is not rotating, the magnitude of the sum vector remains the same as in the “Driving” mode of FIG. 7, e.g. 1.5 times the value of the magnitude of the magnetic induction field vectors of B and C.

The circuits of FIG. 7A are symmetrical with respect to the two three-phase ports of MT 504 (A, B, C) and (a, b, c). Therefore the same reasoning performed for the 3-phase electrical port (A, B, C) can be symmetrically repeated for the second port (a, b, c) concluding that the MT 504 device is reciprocal, therefore the transformer can bidirectionally transfer energy between the two ports, and the rotor does not rotate regardless of the energy direction.

In this example the transformer has a one-to-one transformation ratio, therefore the three-phase voltages at the output from one electric port of MT 502 have the same values as those placed in input on the other port.

Other variants are possible. For example, by changing the number of phases, poles and coils, or by having a different number of turns for each coil, so as to allow different transformation ratios both in operation as a transformer for the “Conduction V2G” mode and for operation as an autotransformer for “Driving and WiFi V2G” mode adding additional taps in the coils to be connected to the (a, b, c) port.

Considering the generic case of MT made up of equally spaced sets of identical Field Coils (503) of N turns each, each one connected to a phase of a P-phase polyphase system, with P the number of phases, the MT magnetic field is rotating. This can be switched from rotating to alternating by changing the magnetic field of the Field Coils (503) connected to one phase (phase ALT), where ALT may be randomly selected amongst the P phases. Defining Bm the magnetic field amplitude of one single set of coils connected to one phase, the magnetic field Bac that applied to ALT generates the linearly polarized alternating magnetic field in MT may be calculated as the Bm value minus the product of P and half of Bm. Changing the magnetic field in ALT from Bm to Bac the magnetic field in MT switches from rotating to alternating. Vice versa, switching from Bac to Bm, the alternating field switches to rotating.

For example, with P equal to three, then Bac is minus half B, that means a field with half amplitude and reversed polarity. The Bm and Bac may be created in the ALT by two arrangements of Field Coils (503) circuits (or two electrically equivalent circuits of multiple field coils) having number of turns N and Nac and inverted polarity connection. The Nac may be calculated as the absolute value of the product of N by Bm divided Bac. Following the preceding example with P equal three, then Nac is half N.

Despite the immense variety of possible combinations of FC 503 and CSS 504 that can produce multitudes of different working MT 502 schemes, all of them generating one, or more, rotating field, useful for “Driving” mode, and one, or more, alternating field, useful for “Conductive V2G” mode, as described in the examples of this embodiment.

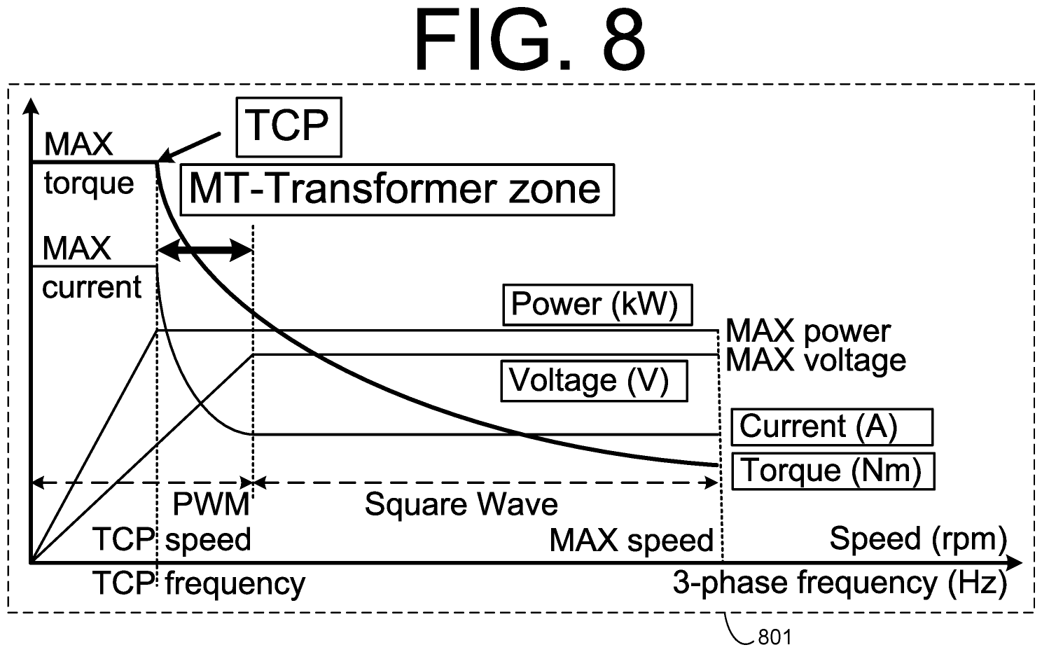

### DETAILED DESCRIPTION—FIG. 8—SIXTH EMBODIMENT

In accordance with other embodiments such MT 502 can be optimized to operate at different maximum power levels for the different operative modes.

Driving mode optimization defines the MT 502 layout configuration and sets its engineering parameters (number of poles, magnetic and electric circuits, wire and magnetic material type, rotor type, etc.) specific for each EV 102 design. Therefore, there is a V/Hz level that corresponds to the maximum MT 502 flux level for each design. An MT 502 Torque Corner Point (TCP) is defined by the optimization of MT 502 as a traction motor alone. However, TCP also defines the electric frequency for operating the MT 502 at its nominal maximum power. As the driving mode optimization does not take into account the grid frequency, the TCP's rotation speed is determined by the EV 102 dynamic and constraints on weight and size.

FIG. 8 shows the MT Typical Torque, Power, frequency characteristic for motor and transformer operative modes. The motor's maximum power is reached at the TCP frequency (that depends on mechanical speed and number of poles) that could be higher or lower than the grid frequency (50/60 Hz) depending where the mechanical constraints set the TCP.

Thus, the overall optimization of IPS 402 is a tradeoff of engineering parameters depending on the maximum power required in the two operating modes “Driving” and “V2G”.

In case the MT 502 optimization as a motor leads to a TCP's frequency that is lower than the grid's frequency, the MT 502 can be connected directly to the grid without the need of the MC 508. In this case, the BI 506 operates at the grid's frequency, controlling its voltage and phase according to the grid's voltage and phase. In this condition, the maximum charging/discharging power and the maximum motor power of MT 502 are the same.

In other cases, the MT 502 optimization as motor could lead to a TCP's frequency higher than the grid's frequency and the MC 508 must be used to avoid magnetic saturation, otherwise, the max power of MT 508 operating as a transformer at power grid frequency could be much lower than the nominal max power of MT 508 operating as motor. The MT 508 optimization as a transformer for “V2G” modes could lead to an electric and magnetic circuit modification to decrease the TCP frequency, however, this would lead to an increase in weight, size, and cost. In order to maintain the same MT 502 size/weight/cost, and power of the two modes, the IPS 402 must include the MC 508.

In V2G mode the IPS generates 3-phase voltages to be delivered to the grid, and an important aspect to be considered is the harmonic content of the generated voltages. In driving mode the MT operates at full flux from start to beyond the TCP in order to obtain high current (torque) at low speed and reduced current/torque at higher speed. In this region the Controller 512 operates the BI 506 in PWM to control frequency, voltage, and current of the MT 502 polyphase voltages; therefore, in these conditions the sinusoidal voltages are produced with low distortion. However, at higher speed the inverter produces sinusoidal voltages with high harmonic content.

When the MT 502 is configured as an isolation transformer, the chain BI 506, MT 502, and MC 508, generates the 3-phase voltages at frequency, voltage and phase of the grid.

EV applications require high torque, high power, and low motor weight. Thus, the TCP frequency is higher than the grid frequency. This means that at grid frequency the available power of MT 502 in transformer configuration is lower than maximum power of the same MT 502 in motor configuration. Therefore, to operate the MT 502 as said isolation transformer at full power, without increasing its weight/size, the 3-phase bidirectional MC 508 must be used.

The MC 508 operates bidirectionally as a frequency converter between MT 502 and AC Power Grid 210, decoupling BI 506 and utility grid frequencies. Using the MC 508, the MT 502 can operate in the PWM area at maximum power regardless of the TCP frequency. This optimal operational area “MT-Transformer zone” is indicated in green in FIG. 8. In this zone MT 502 operates at maximum power minimizing harmonics at the same time. In other words, managing the complexity to control BI 506 and MC 508 at the same time it is possible to maximize the usage of the MT 502 iron/copper/aluminum already optimized as MT 502 in the motor configuration.

Thus, the controller 512 coordinates the BI 506, MT 502 and MC 508, operating at TCP power in both directions for driving and V2G modes. With appropriate software the controller 512 operates the MC 508 as a frequency converter between the P-phase sinusoidal voltages of the BI 506 and the 3-phases, or single phase, and frequency of the grid, or DC microgrid. Using the frequency conversion feature of the MC 508, the BI 506 can operate MT at the TCP frequency (at or near an optimal frequency to track the grid's voltage phase) and the IPS 402 operates as a bidirectional AC isolated charger and discharger at MT 508 max nominal power. In V2G mode the MT 502 is configured as an isolation transformer. When energy flows from the battery to the grid, the MC 508 synthesizes the three-phase power at voltage, frequency, and phase of the grid, starting from the polyphase voltages, at the TCP frequency, supplied from the secondary of MT 502. The primary of MT 502 is powered by the polyphase voltages synthesized by BI 506 at TCP frequency from the DC battery energy.

In the same V2G mode, when the battery is to be charged and energy flows from the grid to the battery 514, the MC 508 synthesizes the polyphase system at TCP frequency from the three-phase grid. The polyphase is transformed by MT 502 and supplied to BI 506 which charges the battery.

The BI 506 and MC 508 can be implemented by means of matrices of IGBT (or other modern fast switching semiconductors) sets, while HV Contactors 510 and CSS 504 can be implemented with contactors or other equivalent devices.

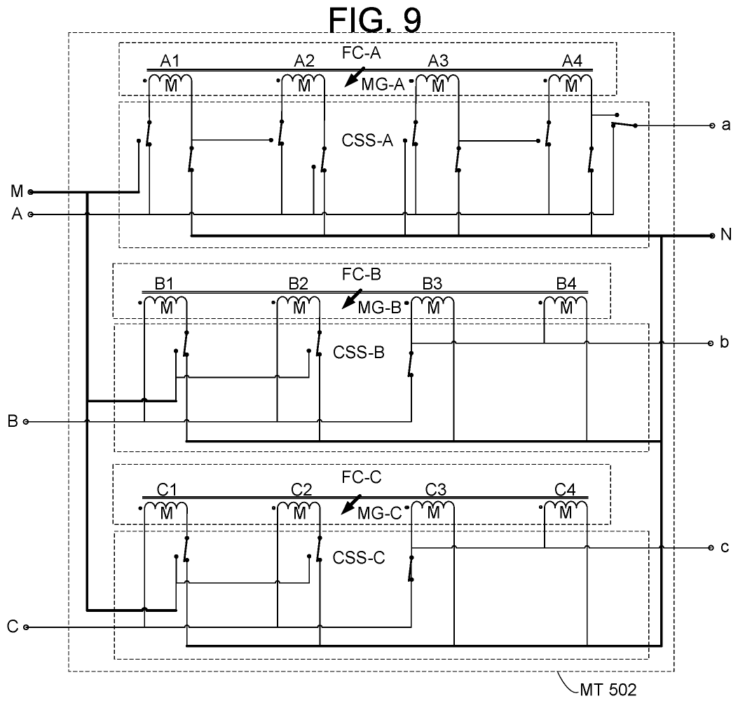

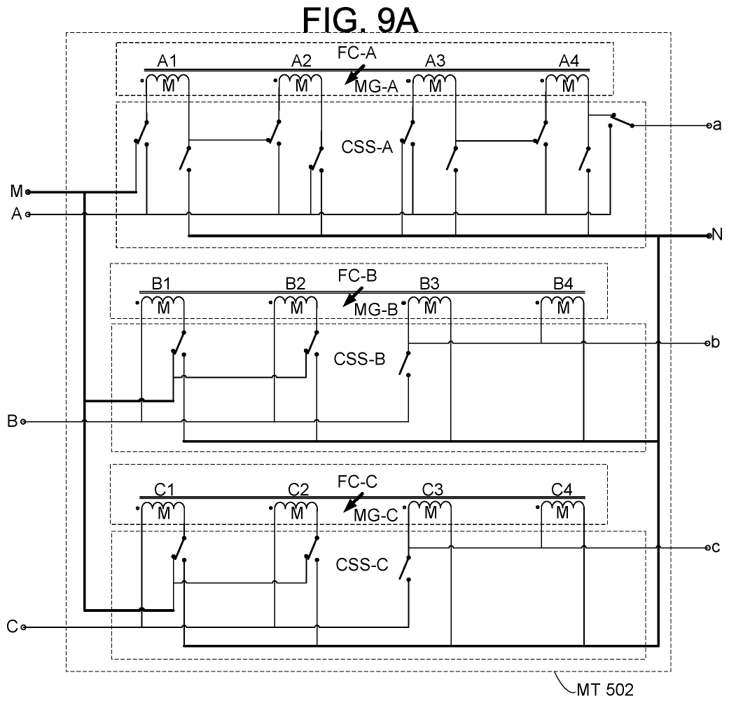

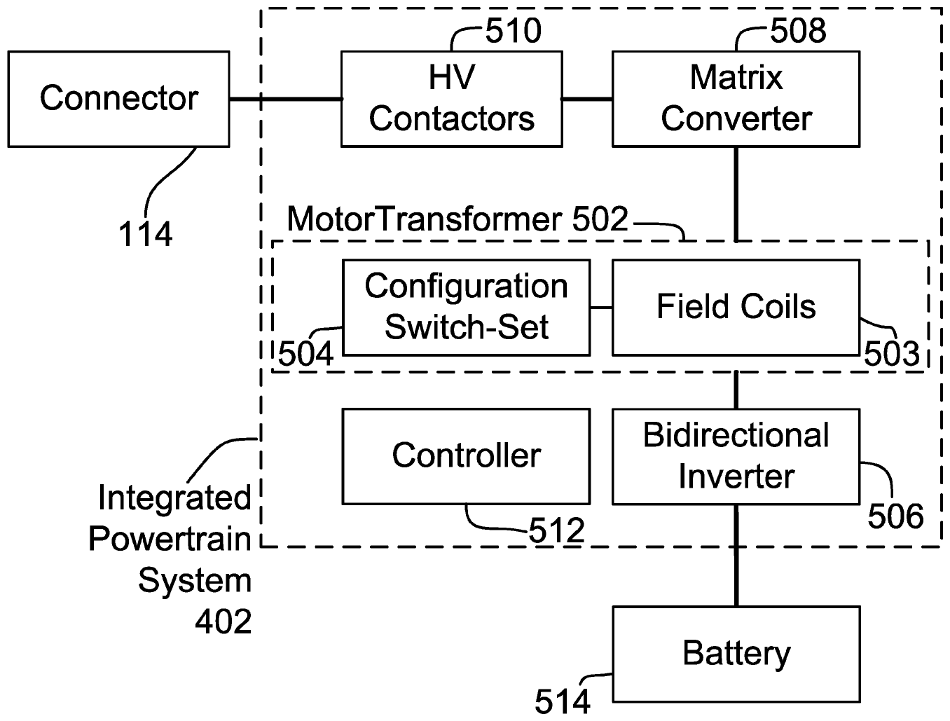

### DETAILED DESCRIPTION—FIGS. 9 AND 9A—SEVENTH EMBODIMENT

Another embodiment of this invention is a MotorTransformer with variable reluctance. Controlling the reluctance of the MT 502 enables the possibility to tune the speed/frequency of the TCP. FIGS. 9 and 9A are similar to FIGS. 7 and 7A except that the magnetic circuit coupling the Field Coils (503) of the primary and secondary windings have controllable magnetic reluctance (shown with arrows on the magnetic cores).

The MT 502 with variable reluctance may be implemented with different shapes and profiles of rotor and/or stator, with or without permanent magnets. The reluctance may be set by controlling the relative angle between the magnetic field defined by the polyphase system angle and the rotor angle position acquired from an angular sensor. The relative angle may be controlled in a closed loop by voltage, current, and phase of the polyphase system supplying MT 502.

In motor configuration, the MT 502 reluctance is controlled according to the angular speed of the rotor to optimally extend the torque-speed range behind TCP.

In transformer configuration, the MT 502 reluctance may be controlled to tune the TCP angular speed at an exact multiple of the utility grid frequency.

### OTHER EMBODIMENTS

The present invention is not limited to connecting the EV 102 to the 3-phase AC Power Grid, or microgrid, 210 by a cable. In other embodiments of the invention charging and discharging can be in AC single phase, or DC, and the connection between the EV 102 and the off board WiFi-AC EVSE 404 can be wireless. Depending on the number of phases, voltages, and available power and load from the grid, or microgrid, 210 the Controller 512 controls the switching sequences of the BI 506, CSS 504, MC 508, or the multi-port Matrix Converter 601. For example, when the embodiment of FIG. 5E operates with AC single phase, or DC, Controller 512 permanently opens the switches (a3, b3, c3) connected to wire L3 (third line of AC 3-phase).

Although the invention has been described in detail with respect to preferred embodiments thereof, it will be apparent, to those skilled in the art, that variations and modifications can be effected in these embodiments without departing from the spirit and scope of the invention. For example, the rotor magnets may be formed from either permanent magnets or electromagnets, the stator may have beveled edges for the stator windings, the directional rotation of rotor may be altered (e.g., by rotating the rotor ninety degrees), or the windings may be electrically commutated to allow for more windings. This invention is not restricted to rotary motors only, other motor configurations are possible, e.g. linear motors.

Further, multiple stators and rotors can be integrated in one single MT 502 and Flywheel 516 can be part of the ESD 112 without departing from the spirit and scope of the invention.

### CONCLUSION, RAMIFICATIONS, AND SCOPE

Accordingly, it can be seen that the EV of the various embodiments can ultra-fast charge and discharge its battery directly from/to the AC Power Grid and without the need of off-board, bulky and expensive, DC EVSE. Any EV equipped with the proposed technology is capable of recharging, and discharging, its battery from/to any energy source, without the need of dedicated infrastructure. This feature is enabled by the novel MotorTransformer device coupled with a Matrix Converter, utilizing the EV motor hardware as an isolation transformer when the vehicle is parked. With the current state of the art, electric motors are powered off and not used when the vehicle is parked and recharging. Thus, the reutilization of the motor hardware, magnetic and conductive material like iron and copper, for the functionality of fast charging and discharging creates additional economic value for vehicle owners and the society at large. Furthermore, the MotorTransformer has the additional advantages in that:
it enables the EV to be plugged directly into the AC Power Grid,
it enables ultra-fast charging and discharging without adding significative weight, size, and cost to the EV,
it makes the off-board DC EVSEs unnecessary,
it reduces complexity and cost of the EV and its infrastructure,
it reduces charging time and range anxiety,
it removes multiple standards interoperability issues,
it can modulate intensity and direction of the energy flow between the EV battery and the grid,
it enables the EV to operate as energy storage for the grid according to DR and DER signals from Power Utilities becoming a distributed energy resource (and not just grid load),
it enables a new approach for using energy stored in EV, for example in case of emergency events and used for demand response and emergency situations for critical facilities (e.g. hospitals, fire stations, etc.) during blackouts.

While the above description contains many specificities, these should not be construed as limitations on the scope of any embodiment, but as exemplifications of various embodiments thereof. Many other ramifications and variations are possible within the teachings of the various embodiments. For example, the MT 504 can be implemented with a number of different phases and coil turns even if the few examples show only specific cases selected to convey the concepts.

Thus the scope of this invention should be determined by the appended claims and their legal equivalents, and not solely by the examples given.

1. A device for an Electric Vehicle, for a driving application, and a vehicle-to-grid application, capable of operating as a motor, and as an isolation transformer, configuring a circuit, generating an alternating linearly polarized magnetic field and a rotating polarized magnetic field, comprising:
a MotorTransformer made up of a plurality of a mechanical moving parts, a magnetic circuits, a field coils, an electric ports, and an electric switches;
means for controllably generating a polarized magnetic field, configuring a MotorTransformer circuit, comprising the mechanical moving parts, the magnetic circuits, the field coils, the electric ports, and the electric switches, as herein described;
and
wherein a first improvement comprising the MotorTransformer configured in various circuits to operate with a plurality of functionalities; in a first example, operating as the motor and as the isolation transformer, the MotorTransformer reduces weight, volume, and cost versus using one motor and one transformer as two separate devices;
and
wherein the MotorTransformer is configured in a first circuit generating the alternating linearly polarized magnetic field, and operating the MotorTransformer as the isolation transformer, comprising two, or more, subsets of the field coils, electrically isolated and magnetically coupled, acting as windings of the isolation transformer, and connected to the electric ports, transferring an electric power bidirectionally, stopping the mechanical moving parts;
and
wherein the MotorTransformer is configured in a second circuit generating the rotating polarized magnetic field, and operating the MotorTransformer as the motor, comprising one electric port connected to the field coils and driving the mechanical moving parts, and transferring the electric power bidirectionally;
and
wherein the MotorTransformer may be configured in a third circuit generating the rotating polarized magnetic field, and operating the MotorTransformer as the motor and the transformer, comprising the electric ports connected to the field coils and driving the mechanical moving parts, and with other electric ports, connected to the field coils and transferring the electric power bidirectionally;
and
wherein the MotorTransformer is installed onboard of the Electric Vehicle operates as the motor for driving, and operates as the isolation transformer for a conductive vehicle-to-grid first application while the Electric Vehicle is parked, and operates as the motor and the transformer for a WiFi vehicle-to-grid second application.

2. The MotorTransformer of claim 1, wherein the polarized magnetic field is controlled by a magnetic field generated by a field coil group, comprising:
a polyphase system with a Np phases connected to the electric ports of the MotorTransformer;
a Np as a number of phases;
a Q as the number of the field coils per phase;
a N as the number of turns of the field coils;
a phase group as a set of Q field coils spaced in the MotorTransformer;
a Npg phase groups as the number of the phase group, with Npg equals the Np;
interleaving the Npg phase groups spaced in the MotorTransformer;
connecting in an orderly manner the Np phases to the Npg phase groups;
a Bm as a magnetic field magnitude in the phase group;
a Brot as the magnetic field magnitude of a counterclockwise and clockwise rotating components of the Bm, wherein the Brot equals half the Bm;
selecting one phase group from the Npg phase groups and identifying it as a ALT group;
a (Npg−1) phase groups, equals the Npg phase groups minus one;
a Balt as the magnetic field magnitude in the ALT group;
a Bp1 as the magnetic field magnitude in the (Npg−1) phase groups;
a Bac as an alternating magnetic field magnitude of the ALT group, wherein the Bac, combined with the Bp1, generates the alternating linearly polarized magnetic field;
calculating the Bac as the Bm minus a product of the Brot and the Np;
and
generating the Balt in the ALT group with Bac value; and
wherein a second improvement comprises setting the Balt at different values modifies the polarized magnetic field of the MotorTransformer from rotating to linear, and vice versa, from driving to stopping, the mechanical moving parts, in a second example from rotating to stopping a rotor;
and
wherein setting the Balt at the Bm generates the rotating polarized magnetic field which drives the mechanical moving parts; and
wherein setting the Balt at the Bac value generates the alternating linearly polarized magnetic field which stops the mechanical moving parts;
and
wherein the alternating linearly polarized magnetic field is oriented orthogonally to an axis of the magnetic field of the ALT group.

3. The MotorTransformer of claim 2, wherein the polarized magnetic field is controlled by a field coil group voltage, comprising:
a V as a polyphase system phase voltage amplitude;
a Valt as a ALT group phase voltage amplitude;
calculating a Vac as the V multiplied by the Bac and divided by the Bm; and
means for setting the Valt at the V and the Vac;
wherein a third improvement comprises setting the Valt at V and Vac values modifies the polarized magnetic field of the MotorTransformer from rotating to linear, from driving to stopping the mechanical moving parts, in a third example from rotating to stopping the rotor, and vice versa;
and
wherein setting the Valt at the V generates the rotating polarized magnetic field which drives the mechanical moving parts;
and
wherein setting the Valt at the Vac generates the alternating linearly polarized magnetic field which stops the mechanical moving parts.

4. The MotorTransformer of claim 2, wherein the polarized magnetic field is controlled by the number of turns and polarity of one group of the field coils, comprising:
calculating a Nac as an absolute value of the product of the N by the Bm divided the Bac;
a Nalt as the number of turns of the ALT group;
defining a terminals as set of terminations of the phase group; and
means for setting Nalt at N and Nac, and reverse the terminals of the ALT group;
wherein a fourth improvement comprises setting the Nalt at N and Nac values, and reversing the terminals of the ALT group, modifies the polarized magnetic field of the MotorTransformer from rotating to linear, from driving the mechanical moving parts to stopping them, in a fourth example from rotating to stopping the rotor, and vice versa;
and
wherein reversing the terminals of the ALT group inverts its magnetic field direction;
and
wherein setting the Nalt at the N generates the rotating polarized magnetic field, driving the mechanical moving parts;
and
wherein setting the Nalt at the Nac generates the alternating linearly polarized magnetic field, stopping the mechanical moving parts.

5. The MotorTransformer of claim 1, wherein the polarized magnetic field is controlled by a polyphase system, comprising:
the polyphase system with a Np phases connected to the electric ports of the MotorTransformer;
defining a polyphase system phase voltage set as set of phase voltages of the polyphase system;
defining a polyphase system phase set as a phase angles set of the polyphase system;
defining a mechanical available power of the MotorTransformer operating as the motor;
defining an electric available power of the MotorTransformer operating as the isolation transformer; and
mean to control the polyphase system modifying the polyphase system phase voltage set and the polyphase system phase set;
wherein controlling the polyphase system controls the mechanical available power and the electric available power, in various functionalities of the MotorTransformer, associated with its various circuit configurations, and in various operative conditions;
and
wherein a fifth improvement comprises controlling the polyphase system modifies the polarized magnetic field of the MotorTransformer from rotating to linear, and vice versa, from driving to stopping, the mechanical moving parts, in an example from rotating to stopping a rotor.

6. The MotorTransformer of claim 3, wherein the magnetic circuits, the field coils, the electric switches, and the electric ports are organized in two polyphase Wye.

7. The MotorTransformer of claim 5, wherein the MotorTransformer circuit is organized in two three-phase Wye.

8. The MotorTransformer of claim 5, wherein the magnetic circuits have a variable reluctance, comprising:
a variable reluctance rotor having reluctance which depends on its rotor angle;
the MotorTransformer with the magnetic circuits, having variable reluctance, made up of the field coils and the variable reluctance rotor;
defining a steering angle as an angle between the polarized magnetic field of the MotorTransformer and the rotor angle; and
defining a field coil magnetic coupling coefficient set as set of magnetic coupling coefficients between the field coils of wherein controlling the steering angle controls the field coil magnetic coupling coefficient set;
and
wherein a sixth improvement comprises controlling the field coil magnetic coupling coefficient set, controlling the mechanical available power and the electric available power in the various functionalities of the MotorTransformer.

9. The MotorTransformer of claim 3 with an inertia system storing mechanical energy, comprising:
a plurality of flywheels; and
means for connecting the flywheels to the mechanical moving parts.

10. The MotorTransformer of claim 4 with an inertia system storing mechanical energy, comprising:
a plurality of flywheels; and
means for connecting the flywheels to the mechanical moving parts.

11. The MotorTransformer of claim 7, with a controller to configure the MotorTransformer circuit.

12. The MotorTransformer of claim 8, with a controller to configure the MotorTransformer circuit.

13. An Integrated Powertrain System (402), comprising:
the MotorTransformer of claim 1 (502), comprising two electric ports, a MT1 and a MT2, the Field Coils (503), and a Configuration Switch-Set (504);
defining the Field Coils (503) as a set of the magnetic circuits and the field coils;
defining the Configuration Switch-Set (504) as the set of the electric switches;
a Matrix Converter (508), comprising, at least, the electric ports, an MC1 and an MC2, and a Matrix Converter Power Switch Set;
a Bidirectional Inverter (506), comprising, at least, the electric ports, a BI1, and a BI2, and a Bidirectional Inverter Power Switch Set;
a HV Contactor (510), comprising, at least, the electric ports, a HVC1, and a HVC2, and a HV Contactors Power Switch Set;
a Power Grid Electric Port for connection of the Integrated Powertrain System to a Power Grid;
a DC Electric Port for connecting the Integrated Powertrain System to a Battery (514);
a Controller (512) connected to the MotorTransformer, the Matrix Converter, the HV Contactor, and the Bidirectional Inverter;
the HV Contactor connected with the HVC1 to the Power Grid Electric Port, and with the HVC2 to the MC1;
the Matrix Converter connected with the MC1 to the HVC2, and with the MC2 to the MT1;
the MotorTransformer connected with the MT1 to the MC2, and with the MT2 to the BI1;
the Bidirectional Inverter connected with the BI1 to the MT2, and with the BI2 to the DC Electric Port; and
means for configuring the Configuration Switch-Set, the HV Contactors Power Switch set, and timing the Bidirectional Inverter Power Switch set and the Matrix Converter Power Switch set, allowing for creation and operation of an isolation transformer circuit configuration and a motor circuit configuration;
wherein a seventh improvement comprises frequency conversion between a polyphase system of the Bidirectional Inverter and that of the Power Grid, enabling the MotorTransformer to operate at same switching frequency in isolation transformer circuit and motor circuit configurations,
as a result, the MotorTransformer as the motor can operate with same power as the MotorTransformer as the isolation transformer, using same hardware resources,
this advancement over state-of-the-art allows the Integrated Powertrain System to electrically isolate the Power Grid from the Battery, enabling ultra-fast charging and discharging of the Battery;
and
wherein the Integrated Powertrain System can operate in conductive vehicle-to-grid application, with the MotorTransformer configured as isolation transformer, transferring an electrical energy, as an Alternating Current (AC), or as a Direct Current (DC), from the Power Grid Electric Port to the Battery, and vice versa;
and
wherein the Integrated Powertrain System can operate in the driving application, transferring the electrical energy from the Battery to kinetic energy of the Electric Vehicle, and vice versa;
and
wherein the Controller (512) configuring the Configuration Switch-Set and the HV Contactors Power Switch Set, controlling a timing of the Bidirectional Inverter Power Switch Set and of the Matrix Converter Power Switch Set;
and
wherein the Controller (512) can configure the Configuration Switch-Set to operate the MotorTransformer as the isolation transformer, transferring alternating current energy from the Matrix Converter to the Bidirectional Inverter, and vice versa;
and
wherein the Controller (512) can configure the Configuration Switch-Set to operate the MotorTransformer as the motor, transforming the electrical energy from the Bidirectional Inverter to the kinetic energy of the Electric Vehicle, and vice versa;
and
wherein the Controller (512) can configure the Configuration Switch-Set to operate the MotorTransformer as the motor and the transformer, comprising additional electric ports connected to the Field Coils;
and
wherein the Integrated Powertrain System can propel the Electric Vehicle and can connect the Electric Vehicle bidirectionally to the, AC or DC, Power Grid, for fast charging and discharging of an onboard battery.

14. The Integrated Powertrain System of claim 13 with means for controlling a switching frequency of the Bidirectional Inverter and the Matrix Converter, maximizing the electric power while operating in the vehicle-to-grid application, comprising:
defining an isolation transformer power as the electric power of the MotorTransformer as the isolation transformer;
defining a motor power as a mechanical power of the MotorTransformer (801);
defining a TCP as a Torque Corner Point of the MotorTransformer;
defining a TCPTC, TCP Tracking Control, as mean for controlling the isolation transformer power, controlling the switching frequency of the Bidirectional Inverter and the Matrix Converter;
defining a GRIDf as a Power Grid frequency (50/60 Hz);
defining a SWf as the switching frequency of the Bidirectional Inverter and the Matrix Converter;
defining a SWfmax as a maximum SWf generating a grid polyphase system at GRIDf, and at total harmonic distortion (THD) lower than a THD threshold;
defining a TCPrpm as a TCP rotation speed in revolution per minute;
defining a TCPf as a frequency in Hertz of a bidirectional inverter polyphase system operating the MotorTransformer as motor at TCP;
calculating the TCPf as the TCPrpm multiplied by Q divided 120;
defining a TCPSWf as the switching frequency of the Bidirectional Inverter, and the Matrix Converter, generating the bidirectional inverter polyphase system at the TCPf; and
the Integrated Powertrain System of claim 13 operating in the vehicle-to-grid application and switching at the SWf;
wherein the Integrated Powertrain System, operating in the vehicle-to-grid application with TCPTC, controls the SWf between TCPSWf and SWfmax to operate the MotorTransformer as the isolation transformer at same maximum power as the MotorTransformer in the motor circuit configuration (801), and keeping the THD lower than the THD threshold;
and
wherein an eighth improvement comprises the frequency conversion, performed by the matrix converter, between the SWf and the GRIDf, maximizing the electric power while operating in the vehicle-to-grid application, controlling the isolation transformer power up to the same motor power, and using the same electric and magnetic circuits.

15. The Integrated Powertrain System of claim 13 with discrete elements, wherein the Bidirectional Inverter (506) and the Matrix Converter (508) are separate and interconnected.

16. The Integrated Powertrain System of claim 13 with a Multi-Port Matrix Converter, comprising:
the Multi-Port Matrix Converter (601) including isolated circuit sections, a bidirectional inverter section and a matrix converter section, controlled by the Controller (512);
the MotorTransformer in claim 13 (502) with, electrically isolated and magnetically coupled, the Field Coils (503), and the Configuration Switch-Set (504) connecting the Battery of an Energy Storage Device (112) to the matrix converter section of the Integrated Powertrain System;
means for setting the Integrated Powertrain System in the vehicle-to-grid application, and in the driving application; and
means for controlling the bidirectional inverter section and the matrix converter section;
wherein the Field Coils operate as a primary and a secondary windings of the isolation transformer when the Integrated Powertrain System is configured in vehicle-to-grid application;
and
wherein the Field Coils operate as a poles sets of the MotorTransformer, operating as the motor, when the Integrated Powertrain System is configured in the driving application;
and
wherein the matrix converter section of the Integrated Powertrain System operates as the Matrix Converter, between the secondary windings and the Power Grid Electric Port, when the Integrated Powertrain System is configured in the vehicle-to-grid application; and
wherein the bidirectional inverter section of the Integrated Powertrain System operates as the Bidirectional Inverter when the Integrated Powertrain System is configured in the driving application;
and
wherein the Configuration Switch-Set (504) connects the Battery of the Energy Storage Device (112) to the matrix converter section of the Integrated Powertrain System when operating in the driving application;
and
wherein an ninth improvement comprises operating the Multi-Port Matrix Converter (601) in the driving application and the vehicle-to-grid application.

17. A 3-phase Integrated Powertrain System operating with a three-phase system, comprising:
the Integrated Powertrain System of claim 13; and
a three-phase MotorTransformer, a three-phase Bidirectional Inverter, a three-phase to three-phase Matrix Converter, a three-phase HV Contactor, and the Controller;
wherein the 3-phase Integrated Powertrain System is connected to an AC Power Grid (210) through an AC Electric Vehicle Supply Equipment (202).

18. The Integrated Powertrain System of claim 13 with the magnetic circuits having a variable reluctance, comprising:
the Integrated Powertrain System of claim 13 with the magnetic circuits having a variable reluctance (MG-A, MG-B, MG-C);
defining a steering angle as an angle between the polarized magnetic field of the MotorTransformer and a rotor angle; and
means for controlling the steering angle to modify the variable reluctance of the magnetic circuits;
wherein modifying the variable reluctance of the magnetic circuits, to an optimized operating set point of the MotorTransformer, maximizes the electric power in the driving application and the vehicle-to-grid application.

19. The Electric Vehicle, comprising:
the Integrated Powertrain System of claim 13;
a Connector (114) for the Power Grid Electric Port wherein the Power Grid Electric Port can be connected to the AC Power Grid and the DC Power Grid;
the Battery connected to the DC Electric Port; and
means for controlling an energy flow amongst the Battery and the Connector;
wherein a tenth improvement comprises the Integrated Powertrain System to fast charge, and fast discharge, the Battery directly from, and to, the Power Grid in an electrically isolated way;
and
wherein the MotorTransformer as motor provides traction to the Electric Vehicle in the driving application;
and
wherein the MotorTransformer as the isolation transformer provides an electric isolation between the Power Grid and the Electric Vehicle while the Electric Vehicle is parked, and the Integrated Powertrain System operates in the conductive vehicle-to-grid application transferring energy from the Power Grid to the Battery, and vice versa;
and
wherein the Electric Vehicle can be connected to the AC Power Grid, or the DC Power Grid.

20. The Electric Vehicle of claim 19 with a WiFi coupler to the Power Grid, comprising:
an EV WiFi Coupler (406) to the Power Grid; and
the means for controlling the energy flow amongst the Battery, the MotorTransformer, and the Power Grid connected through the EV WiFi Coupler;
wherein the MotorTransformer, operating as the motor and as the isolation transformer, or as the motor and an autotransformer, can be driving the Electric Vehicle, and transferring energy from the Power Grid to the Battery, and vice versa;
and
wherein the EV WiFi Coupler can function with an inductive coupling, a capacitive coupling, a radiated coupling.
